(19) United States
(12) Patent Application Publication
(10) Pub. No.: US 2011/0085759 A1
(43) Pub. Date: Apr. 14, 2011

(54) COMPOSITE THIN FILM, AND ATMOSPHERE SENSOR AND OPTICAL WAVEGUIDE SENSOR EACH INCLUDING THE SAME

(75) Inventors: Seung-Woo Lee, Fukuoka (JP); Sergiy O. Korposh, Fukuoka (JP)

(73) Assignee: KITAKYUSHU FOUND.FOR THE ADV.OF IND., SCI. & TECH., Kitakyushu-shi, Fukuoka (JP)

(21) Appl. No.: 12/935,170

(22) PCT Filed: Mar. 27, 2009
(86) PCT No.: PCT/JP2009/056271

§ 371 Date: Sep. 28, 2010

(30) Foreign Application Priority Data
Mar. 28, 2008 (JP) 2008-087580
Sep. 3, 2008 (JP) 2008-225924

(51) Int. Cl. G02B 6/00; B32B 9/00; B82Y 30/00

(52) U.S. Cl. 385/12; 428/317.9; 977/953

(57) ABSTRACT

Disclosed is a composite thin film that can be expanded in surface area of an organic compound film having a surface, on which specific molecules are adsorbed, can increase the number of reactive sites per single layer of the organic compound film, and can be produced with a low number of laminations, and is excellent in productivity. The composite thin film is furthermore excellent in applicability in enabling reactive sites to be modified with a functional molecule to enable application to sensors of high sensitivity and molecular devices, etc., of improved function. The composite thin film is formed on a surface of a support and is characterized in that the composite thin film has at least one layer of each of the following films of (a) and (b) on the surface of the support. That is, (a) a microparticle film formed by adsorption of microparticles, and (b) an organic compound film formed by adsorption of an organic compound.

### TECHNICAL FIELD

The present invention relates to a composite thin film having an organic compound film laminated on a support, and to an atmosphere sensor and an optical waveguide sensor that each includes the composite thin film.

### BACKGROUND ART

Various sensors which detect that a specific molecule has become adsorbed on a surface of a thin film by detecting a change of electrical, magnetic, electrochemical, or optical property, etc., or a change of mass, etc., of the thin film have been known from before. As examples of such sensors, atmosphere sensors, such as gas sensors, humidity sensors, etc., and biosensors, such as immunoassay sensors, etc., are known. Also, new molecular devices that make use of a property of adsorption of a specific molecule onto a surface of a thin film, etc., such as enzyme reactors and light emitting elements that artificially simulate a biological reaction involving an enzyme or other protein or dye molecule, etc., are also being developed.

As a device that applies such a thin film, the present applicant has applied for a patent for “a gas detecting device manufactured by putting a substrate in contact with a metal oxide precursor in a vapor state to form a metal oxide precursor adsorption layer, thereafter hydrolyzing the metal oxide precursor adsorption layer to form a metal oxide layer, then forming an organic adsorption layer on a surface of the metal oxide layer by an electrostatic interaction, and performing further lamination of the metal oxide layer and the organic adsorption layer a plurality of times” (Patent Document 1).

With the invention disclosed in (Patent Document 1), a metal oxide layer and an organic adsorption layer of thickness of 0.1 to 10 nm are laminated alternately, and because gas molecules diffuse readily inside the metal oxide layer and inside the organic adsorption layer, the gas molecules are adsorbed to the organic adsorption layer on the surface, and further, the gas molecules that have diffused through the organic adsorption layer diffuse through a lower metal oxide layer and are then adsorbed by a lower organic adsorption layer. Reactive sites for the gas molecules can be increased in proportion to the number of laminations of the metal oxide layer and the organic adsorption layer, and because a change of mass due to adsorption of gas molecules is thus made large, a gas detecting device of high detection sensitivity can be provided.

Moreover, an optical waveguide sensor, such as a chemical sensor that makes use of an optical fiber or other optical waveguide, makes use of light and thus has such merits as the sensor device itself being contactless and thus enabling explosion-proof measurement to be realized comparatively readily under an environment of high risk of explosion, and also being electromagnetically non-inductive and thus enabling highly reliable measurement and remote measurement to be realized readily under severe electromagnetic noise. Therefore, research and development of optical waveguide sensors are being pursued actively.

For an optical waveguide sensor as a chemical sensor, an arrangement having a sensing film fixed to an optical waveguide is used. Various forms of fixing the sensing film to the optical waveguide are employed, including an optode system with which the sensing film is fixed to an end surface of the optical waveguide, an evanescent absorption system with which the sensing film is fixed to a cylindrical surface of the optical waveguide, an FBG (fiber bragg grating) system, an LPG (long period grating) system, etc. With the optical waveguide sensor of any of these forms, a selective chemical reaction, etc., occurs between the sensing film, fixed to the optical waveguide, and a chemical substance, concentration or other chemical information of the chemical substance is converted to optical information, such as a change of refractive index, change of optical absorption coefficient, etc., of the sensing film, and a signal converted to the optical information is converted to an electrical signal by a general photodetecting system, such as a photodiode, photomultiplier tube, etc.

For example, an optical waveguide sensor according to the evanescent absorption system is a sensor having a sensing film fixed to a cylindrical surface of a core. Although light propagates by repeating total reflection at an interface between the core and a cladding, a weak light called an evanescent wave leaks from the core-cladding interface, therefore, in the optical waveguide sensor, a change of absorption coefficient of the evanescent wave due to chemical change of the sensing film is detected.

An optical waveguide sensor according to the LPG (long period grating) system is a sensor having a sensing film fixed to a cylindrical surface of a cladding in a region where a diffraction grating is formed in a core. With the optical waveguide sensor according to the LPG system, coupling occurs between a fundamental mode light that propagates through the core and a cladding mode light that propagates through the cladding, and characteristics are thus sensitive to a change of refractive index, etc., in a vicinity of the cladding. With this optical waveguide sensor, a change of refractive index, etc., due to a chemical change of the sensing film is detected.

Reactivity of the sensing film and a chemical substance and accompanying changes of physical properties thus greatly influence sensitivity, response speed, selectivity, long-term stability, and other sensor detection performance of the sensor, and research and development are thus being carried out toward improving the reactivity of the sensing film and the chemical substance to improve the sensor detection performance.

As a conventional art related to the evanescent absorption system, “an optical fiber sensor that includes a sensor fiber, having a cladding formed of a transparent resin doped with an active dye that changes in absorptivity according to a type of gas, and a fluorescent fiber, connected to the sensor fiber and having a fluorescent dye doped in at least a core or a cladding, and is used to measure a concentration of the gas by detecting an intensity of light emitted from the sensor fiber” is disclosed in (Patent Document 2).

As a conventional art related to the LPG system, “an optical fiber with a Langmuir-Blodgett film (sensing film) formed on a cylindrical surface” is disclosed in (Non-Patent Document 1). Also, “an optical sensor including a long period grating and a sensing film of polydimethylsiloxane (PDMS), etc., formed on a cylindrical surface” is disclosed in (Patent Document 3).
Patent Document 1: WO2007/114192
Patent Document 2: Japanese Published Examined Patent Application No. H08-3467
Non-Patent Document 1: N. D. Rees, S. W. James and R. P. Tatam, “Optical fiber long-period gratings with Langmuir-Blodgett thin-film overlays”, Opt. Lett., 27, pp. 686-688 (2002)
Patent Document 3: Japanese Published Unexamined Patent Application No. 2008-501936

### DISCLOSURE OF INVENTION

### Technical Problem

However, there were the following demands and issues concerning the conventional arts described above.

(1) The metal oxide layer formed by hydrolysis of the metal oxide precursor adsorption layer is thin with the thickness being 0.1 to 3 nm and has a controlled network and further, the organic adsorption layer formed on the surface of the metal oxide layer is flexible, and thus diffusion of gas molecules occurs comparatively readily within the metal oxide layer and organic adsorption layer. Although use can be made of this property and the number of laminations of the metal oxide layer and the organic adsorption layer can be increased to increase the gas molecule reactive sites and thereby increase the sensitivity, productivity decreases as the number of laminations increases. There was thus a demand for providing a gas detection device of high sensitivity that can be manufactured with a low number of laminations. Further, there was a demand for more improved sensitivity.

In particular, with a gas detection device required to detect a gas whose responsivity is low, the productivity is decreased because a large number of laminations need to be performed to obtain a sensor response of a certain level.

(2) Although depending on the number of laminations, there are cases of ammonia gas detection where although a quantitative response is seen with a low concentration gas of less than 10 ppm, saturation occurs and a quantitative response is no longer exhibited when the concentration exceeds 10 ppm. There was thus a demand for provision of a gas detection device that can accommodate a wide range of concentrations from low concentration to high concentration and exhibits a quantitative response in accordance with concentration, without being saturated with respect to gases of high concentration.
(3) The metal oxide layer formed by hydrolysis of the metal oxide precursor adsorption layer has a dense, packed structure, and there is thus a limit to gas molecule diffusion property and thus limits to gas detection responsivity and restoration property. There was thus a demand for improvement of the gas detection responsivity and restoration property.
(4) Although application to a biosensor, etc., is possible by fixation of a protein, such as an antibody or a receptor, etc., or a nucleic acid, such as DNA, etc., to the organic adsorption layer, proteins and nucleic acids are large in molecular size and thus three-dimensional spaces in which large molecules, such as proteins and nucleic acids can diffuse, is required. However, with the conventional thin film, the spaces in which diffusion of molecules occurs are extremely small, and there was thus a limit to applicable molecules and certain restrictions in terms of application. Moreover, number of proteins and nucleic acids that can be fixed on the surface of the organic adsorption layer is limited, and further, fixed proteins and nucleic acids detach readily, and application to biosensors, etc., was thus difficult due to lack of durability.
(5) With the art disclosed in (Patent Document 2), polyvinyl alcohol doped with thymol blue dye is formed to a film of approximately several μm thickness as a cladding portion on a core material to form the sensor fiber (lines 26 to 29 of left column of p. 2 of the publication). A polyvinyl alcohol solution doped with the dye and adjusted to a comparatively high viscosity is used to form the cladding portion, with a film made of polyvinyl alcohol, having a thickness of approximately several μm, across an entire length of the core material, and not only is control of manufacturing conditions troublesome because the film forming has to be performed under a controlled atmosphere, stability of quality is low because of difficulties in control of the film thickness when forming the cladding portion as a film and in uniform introduction of the dye into the polyvinyl alcohol, and improvements in regard to these aspects were thus demanded.

It is also difficult to change the type of dye or matrix polymer (polyvinyl alcohol) because uniform introduction of the dye into polyvinyl alcohol is difficult, and there is thus an issue of difficulty of forming cladding portions that differ in composition according to the targeted detection object. There is also the issue of the core material and the cladding portion being poor in adhesive property and lacking in durability, and improvements in regard to these aspects were demanded.

(6) With the art disclosed in (Non-Patent Document 1), the Langmuir-Blodgett film is required to have a thickness of 100 nm to several μm in order to detect changes of physical properties of the sensing film. With a Langmuir-Blodgett method, a film with a thickness of approximately 1 nm can be formed in a single operation of film formation, and thus in order to achieve a film thickness of 100 nm to several μm, the film forming operation must be performed no less 100 times, and because the film forming time was thus long, improvement of productivity was demanded.

Also, the Langmuir-Blodgett film has a dense structure of high crystallinity, and thus three-dimensional spaces in which a chemical substance can diffuse are hardly formed inside the film. There is thus a limit to chemical substance diffusion property, and resolution of issues of low sensitivity and response speed of the sensor and, especially, difficulty of detection of chemical substances of large molecular weight was demanded.

(7) In (Patent Document 3), only examples with which the concentration of an analysis object is no less than 100 ppm are described, and it is unclear whether or not an analysis object of low concentration such as approximately 1 ppm can be detected. The optical sensor disclosed in (Patent Document 2) has an issue of being generally low in sensitivity. Also, a wavelength at which optical loss is measured is in a near infrared region of approximately 1550 nm, there is thus an issue that it is difficult to make the detection device compact, lightweight, and low in cost, and improvements in regard to these aspects was demanded.

The present invention meets the above demands of the conventional arts, and an object thereof is to provide a composite thin film, which can be produced with a low number of laminations and thus with excellent productivity due to enabling expansion of surface area of an organic compound film that adsorbs a specific molecule on its surface and enabling increase in reactive sites per single layer of the organic compound film, and which is furthermore excellent in applicability in enabling reactive sites to be modified with a functional molecule to enable application to sensors of high sensitivity and molecular devices, etc., of improved function.

Another object of the present invention is to provide an atmosphere sensor, which not only can be produced with a low number of laminations, is excellent in productivity, and enables improvement in detection sensitivity of gases and humidity due to enabling expansion of the surface area of the organic compound film that adsorbs gas molecules or water molecules and enabling increase in reactive sites per single layer of the organic compound film but is also excellent in molecular diffusion property and responsivity.

Yet another object of the present invention is to provide an optical waveguide sensor, which not only can be produced with a low number of laminations, is excellent in productivity, and enables improvement of detection sensitivity due to enabling expansion of the surface area of the organic compound film that adsorbs a chemical substance and enabling increase in reactive sites per single layer of the organic compound film but is also excellent in molecular diffusion property and responsivity.

### Solution to Problem

To resolve the above issues of the conventional arts, a composite thin film and an atmosphere sensor and an optical waveguide sensor that each includes the composite thin film according to the present invention have the following arrangements.

A composite thin film according to a first aspect of the present invention is a composite thin film formed on a surface of a support and has an arrangement having at least one layer each of the following films of (a) and (b) on the surface of the support. That is, (a) a microparticle film formed by adsorption of microparticles, and (b) an organic compound film formed by adsorption of an organic compound.

The present arrangement provides the following actions.

(1) The microparticle film formed by adsorption of the microparticles is in a state where a fine unevenness is formed on the surface by the microparticles adsorbed on the support or the organic compound film. The organic compound film is formed by adsorption of the organic compound onto the surface of the microparticle film, on which the fine unevenness is formed, and thus in comparison to a case where the organic compound is formed on a smooth surface, the organic compound film can be expanded in surface area, the number of reactive sites per single layer of the organic compound film can be increased, and it thus becomes possible to increase a sensitivity of a sensor or improve a function of a molecular device.
(2) Also, the number of reactive sites per single layer of the organic compound film can be increased by just an amount corresponding to the increase in the surface, thereby enabling the sensor or molecular device to be manufactured with a low number of laminations and thus with excellent productivity.

Here, the forming of the microparticle film by adsorption of the microparticles and the forming of the organic compound film by adsorption of the organic compound may be carried out by an alternate lamination method that makes use of an electrostatic interaction. Specifically, when a surface of a support that has charges opposite those of the microparticles or the organic compound is immersed in a dispersion of the microparticles or a solution of the organic compound, neutralization of the support surface charges by and excess adsorption of the microparticles or the organic compound cause new charges to appear on the support. When the support is then immersed in a solution of the organic compound or a dispersion of the microparticles with charges opposite the newly appeared charges, charge neutralization by and excess adsorption of the microparticles or the organic compound occur and new electrical charges appear on the support. An excess adsorption amount of the microparticles or the organic compound is restricted by charge saturation, a fixed amount of the microparticles or the organic compound is fixed each time, and a composite thin film in which films of a molecular level are laminated can thus be formed. By alternatingly immersing in liquids having net opposite charges, charge neutralization and excess adsorption are repeated alternatingly and alternate adsorption is performed practically indefinitely in any order.

As the support, any support may be used without restrictions in particular as long as it has surface charges or enables introduction of charges on the surface. Specifically, a solid having a functional group, such as a hydroxyl group, carboxyl group, amino group, aldehyde group, carbonyl group, nitro group, carbon-carbon double bond, aromatic ring, etc., on the surface of the support or a solid enabling introduction of such a functional group is used. For example, an inorganic material, such as glass, quartz (silicon oxide), titanium oxide, silica gel, etc., a polymer material, such as polyacrylic acid, polyvinyl alcohol, cellulose, phenol resin, etc., or a metal material, such as iron, silver, aluminum, silicon, etc., may be used. With a support without a functional group on the surface, such as cadmium sulfate, polyaniline, gold, etc., charges can be introduced on the surface by introducing a hydroxyl group or a carboxyl group on the surface. As a means for introducing the hydroxyl group on the surface, a known means, such as air oxidation, wet oxidation, adsorption of mercaptoethanol, contact with hydrogen peroxide, etc., may be employed.

As with the support, any microparticles may be used as the microparticles without restrictions in particular as long as the microparticles have surface charges or enable the introduction of charges on the surfaces. For example, an inorganic material, such as glass, quartz (silicon oxide), titanium oxide, silica gel, etc., a polymer material, such as polyacrylic acid, polyvinyl alcohol, cellulose, phenol resin, etc., a metal material, such as iron, silver, aluminum, silicon, etc., or a magnetic material, such as iron oxide, etc., may be used.

In regard to the shape of the microparticles, microparticles formed to a substantially spherical shape are favorably used. This is because such microparticles are excellent in diffusion property and enable easy control of size of pores formed between the microparticles in the microparticle film.

The surface charges of the microparticles may be either positive charges or negative charges as long as the charges are opposite the charges of the counterpart material onto which the microparticles are to be adsorbed.

As the organic compound, an organic polymer having a charged functional group in a main chain or a side chain is used. As an anionic organic compound, in general, an organic compound having a sulfonic acid, sulfuric acid, carboxylic acid, or other functional group that can be negatively charged, for example, a polystyrene sulfonic acid (PSS), polyvinyl sulfuric acid (PVS), dextran sulfuric acid (PSS), polyvinyl sulfuric acid (PVS), chondroitin sulfuric acid, polyacrylic acid (PAA), polymethacrylic acid (PMA), polymaleic acid, polyfumaric acid, etc., may be used.

As a cationic organic compound, in general, an organic compound having a quaternary ammonium group, amino group, or other functional group that can be positively charged, for example, a polyethyleneimine (PEI), poly(allylamine hydrochloride) (PAH), poly(diallyldimethylammonium chloride) (PDDA), polyvinylpyridine (PVP), polylysine, etc., may be used. Also, a conductive polymer or a poly(aniline-N-propanesulfonic acid) (PAN) or other functional polymer, etc., may be used.

By using the organic compound having charges opposite the surface charges of the microparticles or the support, the organic compound can be adsorbed on the microparticle film or the support to form the organic compound film.

As mentioned above, the microparticle film or the organic compound film may be formed by immersing the surface of the support having charges opposite those of the microparticles or the organic compound in the dispersion of the microparticles or the organic compound solution.

As the dispersion of the microparticles, that with which the microparticles are dispersed in water, an organic solvent, or a mixed liquid of water and an organic solvent is used. A sol may also be used. A pH of the dispersion may be adjusted as necessary by adding hydrochloric acid, etc., or using a buffer solution so that the microparticles are adequately charged.

Although a concentration of the dispersion depends on a diffusion property, etc., of the microparticles, a rigid concentration setting is not required because the adsorption of the microparticles is based on charge neutralization and saturation of the counterpart material. Although as standard, a concentration of 0.1 to 25 wt % is used, the concentration is not restricted to this range.

As the organic compound solution, that with which the organic compound is dissolved in water, an organic solvent, or a mixed liquid of water and an organic solvent is used. A pH of the organic compound solution may be adjusted as necessary by adding hydrochloric acid, etc., or using a buffer solution so that the organic compound is adequately charged.

Although a concentration of the organic compound solution depends on solubility, etc., of the organic compound, a rigid concentration setting is not required because the adsorption of the organic compound is based on charge neutralization and saturation of the counterpart material. Although as standard, a concentration of 0.1 to 1 wt % is used, the concentration is not restricted to this range.

A second aspect of the present invention provides the composite thin film according to the first aspect having an arrangement where the microparticle film is formed on an outermost layer and the organic compound film is formed by adsorption of the organic compound on a surface of the microparticle film.

In addition to the actions provided by the first aspect, the present arrangement provides the following actions.

(1) The organic compound film with many reactive sites is disposed at the outermost layer or between layers so that the sensitivity can be made high, the function can be improved, and the application range can be widened.
(2) Further, the reactive sites at the outermost layer or between layers can be modified by various chemical reactions to provide a composite thin film suited to the application.

A third aspect of the present invention provides the composite thin film according to the first or second aspect having an arrangement where the microparticle film and the organic compound film are laminated alternately a plurality of times.

In addition to the actions provided by the first or second aspect, the present arrangement provides the following action. (1) Molecules that are the object of adsorption in a sensor or other device are first adsorbed by the organic compound film of the outermost layer, and the molecules that are not adsorbed diffuse inside the microparticle film and are adsorbed by the organic compound film of a further inner layer. Also, the sensor or other device is restored by the molecules, which have become adsorbed once on the organic compound film, desorbing and diffusing out of the composite thin film. The molecular diffusion property thus has a large influence on characteristics of the device. Comparatively large pores that are continuous are formed between the microparticles of the microparticle film, and thus the molecular diffusion property is excellent, molecules can be adsorbed rapidly onto respective organic compound film layers that have been laminated a plurality of times via the microparticle films, and desorbed molecules can be made to diffuse out of the composite thin film rapidly, thus enabling a sensor or other device of high sensitivity and excellent responsivity to be obtained.

Here, the alternate, plural lamination of the microparticle film and the organic compound film may be performed by alternately immersing the support in the dispersion of the microparticles and the organic compound solution as described above. By alternately immersing in liquids having net opposite charges, charge neutralization and excess adsorption are repeated alternately, and alternate adsorption is performed practically indefinitely in any order.

A fourth aspect of the present invention provides the composite thin film according to any one of the first to third aspects having an arrangement where the microparticles have an average particle diameter of 10 to 100 nm and preferably 30 to 80 nm.

In addition to the actions provided by any one of the first to third aspects, the present arrangement provides the following action.

(1) The microparticles have an average particle diameter of 10 to 100 nm and preferably 30 to 80 nm, and thus continuous pores of suitable size can be formed between the microparticles of the microparticle film to enable a sensor or other device of excellent molecular diffusion property, extremely high sensitivity and excellent responsivity to be obtained.

Here, as the average particle diameter of the microparticles decreases below 30 nm, the pores formed between the microparticles in the microparticle film tend to be smaller and the molecular diffusion property tends to degrade, and as the average particle diameter increases above 80 nm, the diffusion of the microparticles tends to be slow, a rate of adsorption of the microparticles on the support and the organic compound film decreases in the process of forming the microparticle film, and preparation of a uniform microparticle film tends to be difficult. These tendencies are significant especially when the average particle diameter falls below 10 nm or increases above 100 nm and both of these cases are unfavorable.

Also preferably, the particle diameters of the microparticles are distributed in a range of ±20 nm about the average particle diameter. This is because the porosity of the microparticle film can then be made high and further, pores of substantially equal size can be formed between the microparticles of the microparticle film. Also, when the distribution of particle diameters of the microparticles spreads beyond ±20 nm about the average particle diameter, the pores tend to become narrow due to microparticles with particle diameters smaller than size of the pores entering inside the pores formed between the microparticles.

A fifth aspect of the present invention provides the composite thin film according to any one of the first to fourth aspects having an arrangement where a functional molecule is fixed to both or either of the organic compound film and the microparticle film.

In addition to the actions provided by any one of the first to fourth aspects, the present arrangement provides the following actions.

(1) The reactive sites of the organic compound film and the microparticle film can be modified by the functional molecule to manufacture various types of functional thin films in accordance with characteristics of the functional molecule fixed to the microparticle film or the organic compound film.
(2) Due to the providing of the microparticle film having the pores, a large amount of the functional molecules can also be fixed inside the pores in the microparticle film to enable the function of the composite thin film to be increased by the large amount of fixed functional molecules, and excellent applicability is realized in that although the fixed functional molecule does not detach readily so that excellent durability and long-term stability are provided, depending on the application, detection can also be performed using a property of the fixed functional molecule dissociating due to acid-base, etc.

Here, the functional molecule may be selected suitably according to the application of the composite thin film. In an immunoassay sensor or other biosensor or device using an enzyme reactor or other biological reaction, a protein, such as glucose oxidase, peroxidase, glucoamylase, alcohol dehydrogenase, diaphorase, cytochrome, lysozyme, myoglobin, hemoglobin, etc., a nucleic acid, such as deoxyribonucleic acid (DNA), ribonucleic acid (RNA), etc., or a complex antigen formed by bonding a hapten and a carrier protein, etc., may be used. A hapten refers to an incomplete antigen of low molecular that has a property of bonding with an antibody but does not have immunogenicity for antibody production on its own. A carrier protein refers to a support that bonds to a hapten to make the hapten a complete antigen. As examples of the carrier protein, proteins, such as BSA (bovine serum albumin), OVA (ovalbumin), lactoprotein casein, KLH (keyhole limpet hemocyanin), thyroglobulin, etc., can be cited.

Also, in a case of application to a light emitting device, a functional dye, such as Mordant Yellow, Mordant Blue 29, flavin adenine dinucleotide, Congo red, tetraphenylporphine tetrasulfonic acid, Acid Red 27, Bismarck brown, Indigo carmine, Ponceau S, etc., may be used.

In applications to gas sensors, humidity sensors, ion sensors, and other sensors that detect adsorption of a specific molecule or in applications to separation films, host compounds, including polysaccharides, dendrimer compounds, and ethylenediamines, such as ethylenediamine, ethylenediaminetetraacetate, etc.; cyclic host compounds, including cyclodextrins, such as β-cyclodextrin, etc., calixarenes, and porphyrins, such as tetrakis(sulfophenyl)porphyrin (TSPP), tetrakis(carboxyphenyl)porphyrin (TCPP), etc.; and polymer compounds having a functional group that adsorbs gas molecules, such as polyglutamic acid and other peptide-based polymers, polyacrylic acid, poly(allylamine hydrochloride), polyethyleneimine, polyaniline, polyimide, polyamide, polysulfone, polyvinyl acetate, polypropylene, polyethylene, phenylalanine, polychlorotrifluoroethylene, etc.; may be used.

Also, depending on the application of the composite thin film, microparticles of a metal, such as gold, platinum, etc., may be used as the functional molecule. One type or a plurality of types of such functional molecules may be fixed and used.

The functional molecule may also be fixed by making the functional molecule be adsorbed on the microparticle film or organic compound film by immersing the surface of the microparticle film or the organic compound film having charges opposite those of the functional molecule in a solution or dispersion of the functional molecule in the same manner as described above. In addition to fixation using such an electrostatic interaction, the functional molecule may also be fixed using a chemical reaction (covalent bonding), such as an amino carbonyl reaction, ligand thiol coupling reaction, surface thiol coupling reaction, aldehyde coupling reaction, etc.

For example, a protein or a complex antigen may be fixed by immersing a sensing film in a thiol solution to form a monomolecular film of a thiol compound on a surface of the sensing film, and thereafter employing an amino coupling method to fix the protein or complex antigen via a protein amino group to a carboxyl group of the thiol compound. An antigen (antibody) to be detected can be measured by fixing an antigen (antibody) to a sensing film in advance and applying a displacement method that makes use of binding affinities with respect to an antibody (antigen) of the fixed antigen (antibody) and the antigen (antibody) to be detected that is present in a buffer solution. A principle of the displacement method is to make the antibody (antigen) bonded to the antigen (antibody) fixed in advance be dissociated by the antigen (antibody) to be detected that is present in the buffer solution. By detecting a change of refractive index of the sensing film before and after dissociation of the antibody (antigen), unlabeled detection of the antigen (antibody) to be detected can be performed at high sensitivity and high precision. Hybridization of nucleic acids can also be detected in the same manner.

An atmosphere sensor according to a sixth aspect of the present invention has an arrangement including the composite thin film according to any one of the first to fifth aspects and with which the support is a core of an optical waveguide or is a piezoelectric substrate.

The present arrangement provides the following actions.

(1) The surface of the microparticle film formed by adsorption of the microparticles is in a state where a fine unevenness is formed by the adsorbed microparticles and the organic compound film is formed by adsorption of the organic compound onto the uneven surface, and thus in comparison to a case where the organic compound is formed on a smooth surface, the organic compound film can be expanded in surface area, the number of reactive sites for gas molecules or water molecules per single layer of the organic compound film can be increased, and it thus becomes possible to increase the detection sensitivity with respect to gas or humidity.
(2) Also, the number of reactive sites per single layer of the organic compound film can be increased, thereby enabling the sensor to be manufactured with a low number of laminations and thus with excellent productivity.
(3) The gas molecules or water molecules are first adsorbed by the organic compound film of the outermost layer and the molecules that are not adsorbed diffuse inside the microparticle film and are adsorbed by the organic compound film of a further inner layer. The gas concentration or humidity can be detected by detecting this process. Also, the sensor is restored by the molecules, which have become adsorbed once on the organic compound film, desorbing and diffusing out of the composite thin film. Comparatively large pores that are continuous are formed between the microparticles of the microparticle film, and thus the molecular diffusion property is excellent, molecules can be adsorbed rapidly onto respective organic compound film layers that have been laminated a plurality of times via the microparticle films, and desorbed molecules can be made to diffuse out of the composite thin film rapidly, thus enabling an atmosphere sensor of high sensitivity and excellent responsivity to be manufactured.
(4) The type of detectable gas can be changed according to the type of the functional molecule and selectivity can be increased.

Here, a known means may be employed as a means for detecting an amount of the gas molecules or water molecules adsorbed by the composite thin film of the atmosphere sensor. In a case of an atmosphere sensor with which the composite thin film is formed on a piezoelectric substrate, a mass of the molecules adsorbed on the surface can be measured by a change of frequency of a quartz oscillator. Moreover, in a case of an atmosphere sensor with which a part of a cladding of an optical fiber or other optical waveguide is removed to expose a core and form a core-exposed portion and the composite thin film is formed on the surface of the core-exposed portion, the gas concentration or humidity can be measured from an amount of attenuation of light passing through an interior of the optical fiber or other optical waveguide.

In the case of the atmosphere sensor using the quartz oscillator, a piezoelectric substrate having a characteristic frequency or resonance frequency, made of an inorganic material, such as monocrystalline silicon, silicon nitride, quartz (SiO₂), Bi₁₂GeO₂₀, LiIO₃, LiNbO₃, LiTaO₃, BaTiO₃, or other piezoelectric crystal, a Pb (Zr, Ti)O₃-based, PbTiO₃-based, PbNb₂O₆, or other piezoelectric ceramic, or a ZnO thin film, Bi₁₂GeO₂₀, CdS, or other piezoelectric thin film etc., or made of a polymer, such as polyvinylidene fluoride (PVDF) or other piezoelectric polymer, etc., and is applicable to a QCM (quartz crystal microbalance), elastic surface wave device, microcantilever, etc., may be used as the support. A piezoelectric substrate coated with an electrode made of a metal, such as platinum, gold, silver, copper, etc., or indium tin oxide (ITO), etc., may also be used.

In the case of the atmosphere sensor using the optical fiber or optical waveguide, the core of an optical fiber or optical waveguide formed of an organic based material, such as a fluoropolymer, polymethylmethacrylate-based, polycarbonate, polystyrene, deuterium-containing polymer, or an inorganic based material, such as quartz glass, etc., may be used as the support.

As the organic compound forming the organic compound film, a polymer compound, having a functional group to which the gas molecules to be detected are adsorbed, such as polyglutamic acid or other peptide-based polymer, polyacrylic acid, poly(allylamine hydrochloride), polyethyleneimine, polyaniline, polyimide, polyamide, polysulfone, polyvinyl acetate, polypropylene, polyethylene, phenylalanine, polychlorotrifluoroethylene, etc., is used. The polymer compound may be used upon selecting the type as suited according to the type of the molecules to be detected. For example, in a case where ammonia, pyridine, or other amine-based gas is to be detected, polyacrylic acid or polyglutamic acid is used favorably, in a case where hydrogen sulfide, methyl mercaptan, or other sulfur-containing gas is to be detected, polyethylene, phenylalanine, or polychlorotrifluoroethylene is used favorably, and in a case where formaldehyde or other aldehyde-based gas is to be detected, poly(allylamine hydrochloride), polyethyleneimine, or polyaniline is used favorably.

In the case of the atmosphere sensor using the quartz oscillator, host compounds, including polysaccharides, dendrimer compounds, and ethylenediamines, such as ethylenediamine, ethylenediaminetetraacetate, etc.; cyclic host compounds, including cyclodextrins, such as β-cyclodextrin, etc., calixarenes, porphyrins, such as tetrakis(sulfophenyl)porphyrin (TSPP), tetrakis(carboxyphenyl)porphyrin (TCPP), etc.; and polymer compounds, having a functional group that adsorbs gas molecules, such as polyglutamic acid and other peptide-based polymers, polyacrylic acid, poly(allylamine hydrochloride), polyethyleneimine, polyaniline, polyimide, polyamide, polysulfone, polyvinyl acetate, polypropylene, polyethylene, phenylalanine, polychlorotrifluoroethylene, etc.; may be used as the functional molecule.

In the case of the atmosphere sensor using the optical fiber or other optical waveguide, if an organic dye is contained in the composite thin film, an amount of change of absorptivity of the light passing through the core is amplified in an absorption band specific to the organic dye, and the gas or humidity can thus be detected at high sensitivity. Therefore, a dye compound, such as alizarin yellow, thymol blue, methyl red, or other organic dye, an organic compound or metallo-organic complex, etc., having a ligand of one or a plurality of types among porphyrin derivatives, phthalocyanine derivatives, and pyridine derivatives; or a dye compound that is a complex system of a host compound, such as polysaccharides, dendrimer compounds, ethylenediamines, etc., and an organic dye that is cyanine-based, azlenium-based, pyrylium-based, squarylium-based, croconium-based, quinone/naphthoquinone-based, metal-complex-based, etc., may also be used as the functional molecule.

An optical waveguide sensor according to a seventh aspect of the present invention has an arrangement including the composite thin film according to any one of the first to fifth aspects as a sensing film and with which the support is an optical waveguide.

The present arrangement provides the following actions.

(1) The microparticle film formed by adsorption of the microparticles is in a state where a fine unevenness is formed on the surface by the adsorbed microparticles and when the organic compound film is formed by adsorption of the organic compound onto the microparticle film surface on which the fine unevenness is formed, the organic compound film can be expanded in surface area and the number of reactive sites per single layer of the organic compound film can be increased in comparison to a case where the organic compound is formed on a smooth surface, and it thus becomes possible to increase the sensitivity of the sensor.
(2) Also, the number of reactive sites per single layer of the organic compound film can be increased, thereby enabling the sensing film of high sensitivity to be manufactured with a low number of laminations and thus with excellent productivity.
(3) High sensitivity and high response speed are realized because comparatively large three-dimensional spaces (pores) that are continuous are formed between the microparticles of the microparticle film, and thus the molecular (chemical substance) diffusion property is excellent, molecules can be adsorbed rapidly onto the organic compound film formed inside the three-dimensional spaces (pores), and desorbed molecules can be made to diffuse out of the sensing film rapidly. Further, excellent applicability is provided in that molecules of high molecular weight can be detected because molecules of high molecular weight can also be adsorbed inside the three-dimensional spaces.
(4) The microparticle film and the organic compound film can be formed by making use of an electrostatic interaction, covalent bonding, etc., and with an alternate lamination method using the electrostatic interaction, control of the manufacturing conditions is comparatively readily, and the sensing film is made flexible, high in strength, and excellent in durability because aggregation and organization of the film are made to occur using electrostatic forces.

Here, an optical waveguide or an optical fiber of a slab type, with which a planar core is sandwiched by planar claddings, an embedded type, with which a central core is surrounded by a cladding, etc., may be used as the optical waveguide.

As the optical waveguide sensor with which the sensing film is fixed to the optical waveguide, various systems, such as an optode system with which the sensing film is fixed to an end surface of the optical waveguide, an evanescent absorption system with which the sensing film is fixed to a cylindrical surface of the optical waveguide, an FBG (fiber bragg grating) system, an LPG (long period grating) system, etc., may be employed.

The optical waveguide formed of an organic based material, such as a polyimide-based resin, polyamide-based resin, polymethylmethacrylate-based, polycarbonate, polystyrene, deuterium-containing polymer, or an inorganic based material, such as quartz glass, etc., may be used without restrictions in particular as long as it has surface charges or enables introduction of charges on the surface. Specifically, it suffices that the optical waveguide have a functional group, such as a hydroxyl group, carboxyl group, amino group, aldehyde group, carbonyl group, nitro group, carbon-carbon double bond, aromatic ring, etc., or enables introduction of such a functional group on the surface. For example, as a means for introducing a hydroxyl group onto the surface, a known means, such as air oxidation, wet oxidation, contact with potassium hydroxide or hydrogen peroxide, etc., may be employed.

The microparticles, organic compound, and functional molecule are as described above, and the microparticle film or the organic compound film can be formed by immersing the surface of the optical waveguide, having charges opposite those of the microparticles or the organic compound, in the dispersion of the microparticles or the organic compound solution.

The number of times of lamination of the microparticle film and the organic compound film may be decided as suited, for example, in a range of one to twenty times according to the type and particle diameter of microparticles, the type of the organic compound, etc., so that a film forming time is short and the optical waveguide sensor is high in sensitivity.

An eighth aspect of the present invention provides the optical waveguide sensor according to the seventh aspect having an arrangement where a long period grating is formed in the optical waveguide and the sensing film is fixed to the cladding of the optical waveguide.

In addition to the actions provided by the seventh aspect, the present arrangement provides the following action.

(1) The LPG type sensor in which the long period grating is formed in the optical waveguide is high in sensitivity with respect to the change of refractive index of the sensing film and enables realization of a sensor of high sensitivity and high response speed.

Here, the long period grating is a periodic refractive index modulated region formed inside the core and along an axis of the optical waveguide. The refractive index period may be selected as suited within a range of approximately 10 to 1500 μm.

The long period grating can normally be formed by forming a periodic, photoinduced refractive index variation by irradiating light locally at predetermined intervals along an axial direction of an optical waveguide having a photosensitive core. For example, by preparing a quartz glass based optical waveguide having germanium, phosphorus, or other photosensitive material added to the core, disposing an intensity modulation mask, in which light transmitting portions and light shielding portions are aligned alternately at intervals corresponding to the period of the grating, on the optical waveguide, and irradiating ultraviolet light, etc., the region in which the refractive index is modulated at a period substantially equal to the alignment period of the light transmitting portions, that is, the grating can be formed on the core.

The forming of the long period grating and the fixing of the sensing film may be performed at one or a plurality of locations of the optical waveguide. If the forming of the long period grating and the fixing of the sensing film are performed at a plurality of locations that are spaced apart by intervals in a traveling direction of light, excellent applicability is provided in that the types of the microparticles or organic compounds of the sensing films disposed across the intervals can then be differed to make different the type of molecule detectable by each sensing film.

A ninth aspect of the present invention provides the optical waveguide sensor according to the seventh or eighth aspect having an arrangement where a core-exposed portion is formed at a part of the cladding of the optical waveguide and the sensing film is fixed to the core-exposed portion.

In addition to the actions provided by the seventh or eighth aspect, the present arrangement provides the following action. (1) A sensor of an evanescent absorption type in which the sensing film is formed at the core-exposed portion is high in sensitivity with respect to a change of optical absorption coefficient of the sensing film and enables realization of a sensor of high sensitivity and high response speed.

Here, the core-exposed portion can be formed by dissolving a part of the cladding by a chemical, such as hydrogen fluoride, 1-4 dioxane, etc. Also, in a case where the cladding is made of an organic based material, the core-exposed portion can be formed by melting the part of the cladding by flame or shaving off the part by a cutter, etc.

As a length of the core-exposed portion, 10 to 50 mm and preferably 10 to 30 mm along the traveling direction of light is used favorably. As the core-exposed portion becomes shorter than 10 mm, the change of absorptivity of light (optical absorption coefficient) tends to become small and the sensor sensitivity tends to degrade. The number of times of lamination of the microparticle film and the organic compound film must consequently be increased and the productivity tends to decrease.

Although as the core-exposed portion becomes longer, a sufficient sensitivity can be achieved with a fewer number of times of lamination because the change of absorptivity increases, as the portion becomes longer than 30 mm, the change of absorptivity reaches saturation and the sensor sensitivity tends to decrease oppositely, and a length greater than 50 mm is unfavorable in that this tendency becomes significant.

As the organic compound or the functional molecule, alizarin yellow, methyl red, thymol blue, or other dye compound that is sultone-based, diazo-based, cyanine-based, azlenium-based, pyrylium-based, squarylium-based, croconium-based, quinone/naphthoquinone-based, metal-complex-based, etc., is used favorably. This is because the amount of change of absorptivity of the light passing through the core is amplified in the absorption band specific to the dye compound and the detection object can thus be detected at high sensitivity. Among these, an organic compound or metallo-organic complex, etc., having a ligand of one or a plurality of types among porphyrin derivatives, phthalocyanine derivatives, and pyridine derivatives is used favorably. With these materials, hysteresis between humidification and dehumidification is unlikely to occur because capillary concentration of adsorbed water molecules is unlikely to occur, and thus humidity measurement of high precision can be performed with excellent reproducibility. Also, gas detection of high sensitivity and high precision can be performed because the absorption coefficient is extremely high, stable redox characteristics are exhibited, and the absorption band thus changes sensitively according to adsorption and desorption of molecules, and further because hysteresis is unlikely to occur. Also, a porphyrin derivative has a sharp absorption band near 400 to 500 nm called a Soret band, and an absorption band near 500 to 700 nm called a Q band, and because these overlap with near-ultraviolet and visible wavelengths, a compact sensor that makes use of near-ultraviolet and visible light can be manufactured.

As examples of the organic dye of the organic compound or metallo-organic complex, etc., having a ligand of one or a plurality of types among porphyrin derivatives, phthalocyanine derivatives, and pyridine derivatives, porphyrins, such as tetrakis(sulfophenyl)porphyrin, etc., porphyrin complexes bonded with Fe, Co, Mn, Zn, Ni, Ru, Cr, etc., metal phthalocyanines, in which two central hydrogen atoms are substituted by Cr, Zn, Cu, Co, Ni, Mn, Fe, etc., pyridine derivatives, such as bipyridines, terpyridines, phenanthrolines, etc., and complexes made of a pyridine derivative and a transition metal ion can be cited. Such metallo-organic complexes are used favorably in the case where the object of detection is humidity. This is because, adsorption of a water molecule occurs by complex formation of the water molecule and the central metal ion of the metallo-organic complex, equilibrium of the complex formation and desorption occurs rapidly according to humidity conditions, and thus humidity measurement of a high precision of no more than 1% relative humidity is enabled without being influenced by gases and other obstructing components.

The forming of the core-exposed portion and the fixing of the sensing film may be performed at one or a plurality of locations of the optical waveguide. If the forming of the core-exposed portion and the fixing of the sensing film are performed at a plurality of locations that are spaced apart by intervals in the traveling direction of light, excellent applicability is provided in that the types of the microparticles or organic compounds of the sensing films disposed across the intervals can then be differed to make different the type of molecule detectable by each sensing film.

### ADVANTAGEOUS EFFECTS OF INVENTION

As described above, by the composite thin film and the atmosphere sensor and the optical waveguide sensor that each includes the composite thin film according to the present invention, the following beneficial effects are provided.

By the first aspect of the present invention, the following effects are provided.
(1) The organic compound film is formed by adsorption of the organic compound on the surface of the microparticle film having the fine unevenness formed on the surface, and thus in comparison to the case where the organic compound is formed on a smooth surface, the organic compound film can be expanded in surface area and the number of reactive sites per single layer of the organic compound film can be increased, thereby enabling the providing of the composite thin film that enables a sensor of high sensitivity or a molecular device of improved function to be obtained.
(2) The number of reactive sites per single layer of the organic compound film can be increased, thereby enabling the providing of the composite thin film of excellent productivity that enables the sensor or molecular device to be manufactured with a low number of laminations.

By the second aspect of the present invention, the following effects are provided in addition to the effects provided by the first aspect.

(1) In particular, the organic compound film with many reactive sites is disposed at the outermost layer, thereby enabling the providing of the composite thin film that is high in sensitivity and enables improvement in functions and widening of the application range.
(2) Further, the reactive sites at the outermost layer or between layers can be modified by various chemical reactions, thereby enabling the providing of the composite thin film that is suited to the application.

By the third aspect of the present invention, the following effect is provided in addition to the effects provided by the first or second aspect.

(1) Comparatively large pores that are continuous are formed between the microparticles of the microparticle film, and thus the molecular diffusion property is excellent, molecules can be adsorbed rapidly onto respective organic compound film layers that have been laminated a plurality of times via the microparticle films, and desorbed molecules can be made to diffuse out of the composite thin film rapidly, thereby enabling the providing of the composite thin film that enables a sensor or other device of high sensitivity and excellent responsivity to be obtained.

By the fourth aspect of the present invention, the following effect is provided in addition to the effects provided by any one of the first to third aspects.

(1) Continuous pores of suitable size can be formed between the microparticles of the microparticle film, thereby enabling the providing of the composite thin film that enables a sensor or other device of excellent molecular diffusion property, extremely high sensitivity and excellent responsivity to be obtained.

By the fifth aspect of the present invention, the following effects are provided in addition to the effects provided by any one of the first to fourth aspects.

(1) The composite thin film of excellent applicability that enables various types of functional thin films to be manufactured in accordance with the characteristics of the functional molecule fixed to the microparticle film or the organic compound film can be provided.
(2) Due to the providing of the microparticle film having the pores, a large amount of the functional molecules can also be fixed inside the pores in the microparticle film to enable the function of the composite thin film to be improved by the large amount of the fixed functional molecules, and the composite thin film of excellent applicability, which is not only excellent in durability and long-term stability due to the fixed functional molecule not detaching readily but also enables, depending on the application, detection using the property of the fixed functional molecule dissociating due to acid-base, etc., can be provided.

By the sixth aspect of the present invention, the following effects are provided.

(1) The organic compound film is formed by adsorption of the organic compound on the surface of the microparticle film, on which the fine unevenness is formed, and thus in comparison to the case where the organic compound is formed on a smooth surface, the organic compound film can be expanded in surface area and the number of reactive sites for gas molecules or water molecules per single layer of the organic compound film can be increased, thereby enabling the providing of the atmosphere sensor of high gas or humidity detection sensitivity.
(2) The number of reactive sites per single layer of the organic compound film can be increased, thereby enabling the sensor to be manufactured with a low number of laminations and the atmosphere sensor of excellent productivity to be provided.
(3) Comparatively large pores that are continuous are formed between the microparticles of the microparticle film, and thus the molecular diffusion property is excellent, molecules can be adsorbed rapidly onto respective organic compound film layers that have been laminated a plurality of times via the microparticle films, and desorbed molecules can be made to diffuse out of the composite thin film rapidly, thereby enabling the providing of the atmosphere sensor of high sensitivity and excellent responsivity.
(4) The atmosphere sensor that is high in selectivity and enables the type of detectable gas to be changed according to the type of the functional molecule can be provided.

By the seventh aspect of the present invention, the following effects are provided.

(1) The organic compound film is formed by adsorption of the organic compound on the surface of the microparticle film, on which the fine unevenness is formed, and thus in comparison to the case where the organic compound is formed on a smooth surface, the organic compound film can be expanded in surface area and the number of reactive sites per single layer of the organic compound film can be increased, thereby enabling the providing of the optical waveguide sensor of high detection sensitivity.
(2) The number of reactive sites per single layer of the organic compound film can be increased, thereby enabling the optical waveguide sensor that is excellent in productivity and has the sensing film of high sensitivity to be provided with a low number of laminations.
(3) Comparatively large pores that are continuous are formed between the microparticles of the microparticle film, and thus the molecular diffusion property is excellent, molecules can be adsorbed rapidly onto the respective layers of the organic compound films that are laminated a plurality of times via the microparticle films, and the desorbed molecules can be made to diffuse out of the sensing film rapidly, thereby enabling the optical waveguide sensor of high sensitivity and excellent responsivity to be provided.
(4) The optical waveguide sensor of excellent durability that includes the sensing film having flexibility and high strength can be provided.

By the eighth aspect of the present invention, the following effects are provided in addition to the effects provided by the seventh aspect.

(1) The LPG type sensor in which the long period grating is formed in the optical waveguide is high in sensitivity with respect to the change of refractive index of the sensing film and enables the providing of the sensor of high sensitivity and high response speed.
(2) A high refractive index is obtained readily by selection of the film material and control of film thickness and accordingly, the optical waveguide sensor with which a specific spectral change can be made to occur can be provided.

By the ninth aspect of the present invention, the following effect is provided in addition to the effects provided by the seventh or eighth aspects.

(1) The sensor of the evanescent absorption type in which the sensing film is formed at the core-exposed portion is high in sensitivity with respect to a change of optical absorption coefficient of the sensing film and enables the sensor of high sensitivity and high response speed to be provided.

### BRIEF DESCRIPTION OF DRAWINGS

FIG. 1 is a schematic sectional view of a composite thin film according to Embodiment 1 of the present invention.

FIG. 2 is a schematic sectional view of a composite thin film according to Embodiment 2 of the present invention.

FIG. 3 is a schematic view of an optical waveguide sensor according to Embodiment 3.

FIG. 4 is a schematic view of an optical waveguide sensor according to Embodiment 4.

FIG. 5 shows schematic diagrams for explaining principles of a method for measuring an intermolecular interaction using the optical waveguide sensor according to Embodiment 4.

FIG. 6 is a schematic view of an optical waveguide sensor according to Embodiment 5.

FIG. 7 is a schematic view of an optical waveguide sensor according to Embodiment 6.

FIG. 8 is an SEM photograph of a surface and a fracture section of a composite thin film of an atmosphere sensor of Experimental Example 2.

FIG. 9 is an SEM photograph of a fracture section of the composite thin film of the atmosphere sensor of Experimental Example 2.

FIG. 10 is a diagram of time variations of adsorption amounts of a functional molecule β-CD in atmosphere sensors of Experimental Examples 4 to 6.

FIG. 11 is a diagram in which time response characteristics of frequency changes of atmosphere sensors of Experimental Examples 14, 15, 17, and 18 and Comparative Examples 1 and 2 are plotted according to ammonia gas concentration.

FIG. 12 is a diagram, for the atmosphere sensors of Experimental Examples 14, 15, 17, and 18 and Comparative Examples 1 and 2, showing relationships of the frequency change and ammonia concentration at 20 seconds after making ammonia gas flow into a flow cell in the cases of Comparative Examples 1 and 2 and at equilibrium after making ammonia gas flow into the flow cell in the cases of Experimental Examples 14, 15, 17, and 18.

FIG. 13 is a diagram in which time response characteristics of frequency changes of atmosphere sensors of Experimental Examples 2, 5, and 6 and Comparative Example 3 are plotted according to aniline gas concentration.

FIG. 14 is a diagram in which time response characteristics of frequency changes of the atmosphere sensors of Experimental Examples 2, 5, and 6 and Comparative Example 3 are plotted according to pyridine gas concentration.

FIG. 15 is a diagram in which time response characteristics of frequency changes of the atmosphere sensors of Experimental Examples 2, 8, and 9 and Comparative Example 3 are plotted according to benzene gas concentration.

FIG. 16 is a diagram in which time response characteristics of frequency changes of the atmosphere sensors of Experimental Examples 2, 11, and 12 and Comparative Example 3 are plotted according to toluene gas concentration.

FIG. 17 is a diagram in which time response characteristics of frequency changes of the atmosphere sensors of Experimental Examples 2, 11, and 12 and Comparative Example 3 are plotted according to p-xylene gas concentration.

FIG. 18 is a diagram in which time response characteristics of frequency changes of the atmosphere sensors of Experimental Examples 2, 11, and 12 and Comparative Example 3 are plotted according to acetaldehyde gas concentration.

FIG. 19 is a diagram in which time response characteristics of frequency changes of the atmosphere sensors of Experimental Examples 2, 11, and 12 and Comparative Example 3 are plotted according to cyclohexane gas concentration.

FIG. 20 is a diagram of a time variation of a detected spectrum.

FIG. 21 is a diagram of wavelengths and intensities of detected spectra.

FIG. 22 is a diagram of spectral intensity at 800 nm wavelength with respect to elapsed time.

FIG. 23 is a diagram of absorbances due to a functional molecule (TSPP) fixed to optical waveguide sensors of Experimental Examples 21 to 23.

FIG. 24 is a diagram of time variations of spectral intensity difference at 700 nm when the optical waveguide sensors of Experimental Examples 21 to 23 are exposed to 0.5 ppm ammonia gas.

FIG. 25 is a diagram of absorbances due to a functional molecule (TSPP) fixed to optical waveguide sensors of Experimental Examples 24 to 28.

FIG. 26A is a diagram of a differential spectra when the optical waveguide sensor of Experimental Example 27 is exposed to ammonia gases of low concentrations, and FIG. 26B is an enlarged view of the differential spectra near 720 nm.

FIG. 27 is a diagram of ammonia gas concentration dependence of a spectral intensity (710 nm) when the optical waveguide sensor of Experimental Example 27 is exposed to ammonia gases of low concentrations.

FIG. 28 is a diagram of time variations of spectral intensity difference at 700 nm when the optical waveguide sensors of Experimental Example 24 and Comparative Example 4 are exposed to ammonia gas of 10 ppm.

### REFERENCE SIGNS LIST

1, 1a composite thin film
2 support
3, 5, 17, 27 microparticle film
4, 6, 18, 28 organic compound film
7, 19, 29 functional molecule
11, 11a optical waveguide sensor
12 optical waveguide
13 core
14 long period grating
15 cladding
16, 26 sensing film
21, 21a optical waveguide sensor
22 optical waveguide
23 core
24 cladding
25 core-exposed portion
30 carrier microparticle
31 monoclonal antibody
32 antigen

### BEST MODE FOR CARRYING OUT THE INVENTION

Best modes for carrying out the present invention shall now be described with reference to the drawings.

### Embodiment 1

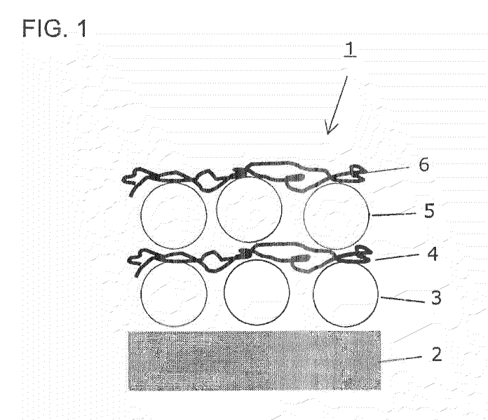

FIG. 1 is a schematic sectional view of a composite thin film according to Embodiment 1 of the present invention.

In FIG. 1, 1 is the composite thin film according to Embodiment 1 that is formed on a support 2 to be described next, 2 is a support made of an inorganic material, such as glass, quartz (silicon oxide), titanium oxide, silica gel, etc., a polymer material, such as polyacrylic acid, polyvinyl alcohol, cellulose, phenol resin, etc., a metal material, such as iron, silver, aluminum, silicon, etc., or a piezoelectric substrate made of a piezoelectric crystal, such as a monocrystalline silicon coated with an electrode of gold, etc., or a piezoelectric ceramic, etc., 3 is a microparticle film, formed by adsorption of microparticles, formed of an inorganic material, such as glass, quartz (silicon oxide), titanium oxide, silica gel, etc., a polymer material, such as polyacrylic acid, polyvinyl alcohol, cellulose, phenol resin, etc., a metal material, such as iron, silver, aluminum, silicon, etc., or a magnetic material, such as iron oxide, etc., to a substantially spherical shape with an average particle diameter of 10 to 100 nm and preferably 30 to 80 nm, onto a surface of the support 2, 4 is an organic compound film formed by an organic compound, such as a polystyrene sulfonic acid (PSS), polyvinyl sulfuric acid (PVS), dextran sulfuric acid (PSS), polyvinyl sulfuric acid (PVS), dextran sulfuric acid, chondroitin sulfuric acid, polyacrylic acid (PAA), polymethacrylic acid (PMA), polymaleic acid, polyfumaric acid, polyethyleneimine (PEI), poly(allylamine hydrochloride) (PAH), poly(diallyldimethylammonium chloride) (PDDA), polyvinylpyridine (PVP), polylysine, etc., adsorbed on a surface of the microparticle film 3, 5 is a microparticle film formed by adsorption of the microparticles on a surface of the organic compound film 4, and 6 is an organic compound film formed by the organic compound adsorbed on a surface of the microparticle film 5.

A method for manufacturing the composite thin film according to Embodiment 1 with the arrangement described above shall now be described.

After introducing charges on the surface of the support 2 by a means such as immersing the support 2 in 2-aminoethanethiol, the support 2 is immersed in a dispersion of the microparticles having charges opposite those of the surface of the support 2 to make the microparticles be adsorbed on the support 2 and thereby form the microparticle film 3. The support 2 is then immersed in a solution of the organic compound having charges opposite those of the microparticles to make the organic compound be adsorbed on the surface of the microparticle film 3 formed on the support 2 and thereby form the organic compound film 4. The forming of the microparticle film 5 on the surface of the organic compound film 4 and the forming of the organic compound film 6 on the surface of the microparticle film 5 are then repeated alternately in likewise manner to manufacture the composite thin film 1.

The following actions are provided by the composite thin film according to Embodiment 1 arranged as described above.

(1) The microparticle films 3 and 5, formed by adsorption of the microparticles on the surfaces of the support 2 and the organic compound film 4, are in a state where a fine unevenness is formed on the surface by the adsorbed microparticles. The organic compound films 4 and 6 are formed by adsorption of the organic compound on the surfaces of the microparticle films 3 and 5, on each of which the fine unevenness is formed, and thus in comparison to a case where the organic compound is formed on a smooth surface, the organic compound films 4 and 6 can be expanded in surface area, the number of reactive sites per single layer of the organic compound film can be increased, and it thus becomes possible to increase a sensitivity of a sensor or improve a function of a molecular device.
(2) Also, the number of reactive sites per single layer of the organic compound film can be increased, thereby enabling the sensor or molecular device to be manufactured with a low number of laminations and thus with excellent productivity.
(3) Molecules that are the object of adsorption in the sensor or other device are first adsorbed by the organic compound film 6 of the outermost layer and the molecules that are not adsorbed diffuse inside the microparticle film 5 and are adsorbed by the organic compound film 4 that is a further inner layer. Also, the sensor or other device is restored by the molecules, which have become adsorbed once on the organic compound film 4, desorbing and diffusing out of the composite thin film 1. The molecular diffusion property thus has a large influence on characteristics of the device. Comparatively large pores that are continuous are formed between the microparticles of the microparticle films 3 and 5, and thus the molecular diffusion property is excellent, molecules can be adsorbed rapidly onto the respective layers of the organic compound films 4 and 6 that have been laminated a plurality of times via the microparticle films 3 and 5, and desorbed molecules can be made to diffuse out of the composite thin film 1 rapidly, thereby enabling a sensor or other device of high sensitivity and excellent responsivity to be obtained.
(4) The microparticles have an average particle diameter of 10 to 100 nm and preferably 30 to 80 nm, and thus continuous pores of suitable size can be formed between the microparticles of the microparticle films 3 and 5 to enable a sensor or other device of excellent molecular diffusion property, extremely high sensitivity and excellent responsivity to be obtained.

Although with the present embodiment, a case where the compound thin film 1 is formed by laminating the microparticle film 3, the organic compound film 4, the microparticle film 5, and the organic compound film 6 alternately in that order on the support 2 was described, in a case where the net charge of the solution of the organic compound is opposite the surface charge of the support 2, the composite thin film may be formed by laminating the organic compound film, the microparticle film, and the organic compound film alternately in that order on the support 2. The same actions are provided in this case as well.

### Embodiment 2

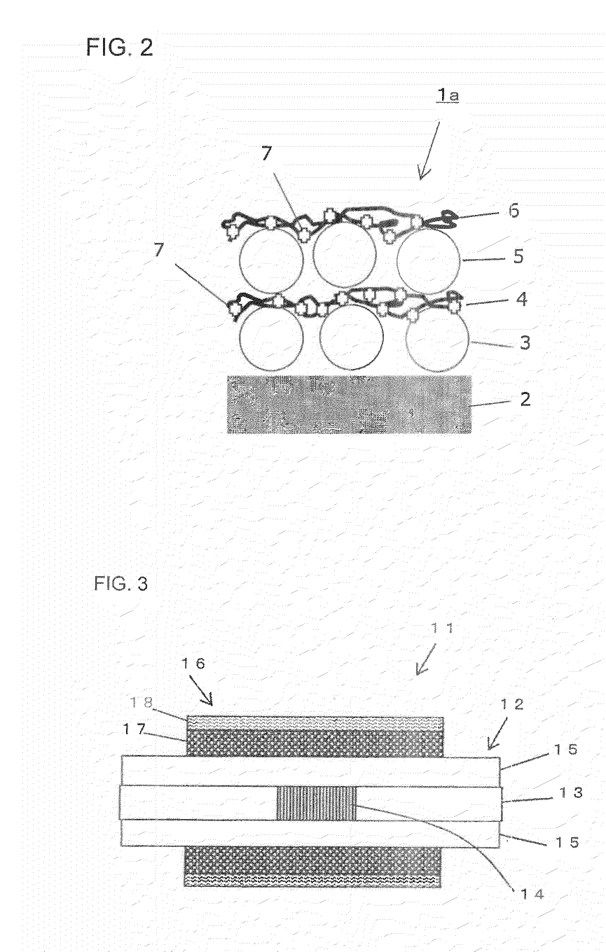

FIG. 2 is a schematic sectional view of a composite thin film according to Embodiment 2 of the present invention. Moreover, portions that are the same as those of Embodiment 1 are provided with the same symbols and description thereof is omitted.

In FIG. 2, 1a is the composite thin film according to Embodiment 2, and 7 is a functional molecule, among glucose oxidase, hemoglobin, or other protein, deoxyribonucleic acid (DNA) or other nucleic acid, Mordant Yellow, or other functional dye, a polymer compound such as polysaccharides, cyclodextrins, porphyrins, polyacrylic acid, etc., or a metal microparticle, etc., and is fixed by an electrostatic interaction or a chemical reaction to the organic compound films 4 and 6 and the microparticle films 3 and 5.

A method for manufacturing the composite thin film according to Embodiment 2 with the arrangement described above shall now be described.

The composite thin film 1a is manufactured by laminating the microparticle film 3, the organic compound film 4, the microparticle film 5, and the organic compound film 6 alternately in that order on the support 2 in the same manner as described in Embodiment 1, and then immersing the support 2 in a solution or a dispersion of the functional molecule 7 having charges opposite those of the organic compound making up the organic compound films 4 and 6 to fix the functional molecule 7 by an electrostatic interaction or a chemical reaction to the organic compound films 4 and 6 and the microparticle films 3 and 5.

In addition to the actions described in Embodiment 1, the following actions are provided by the composite thin film according to Embodiment 2 arranged as described above.

(1) Various functional thin films can be manufactured in accordance with characteristics of the functional molecule 7 fixed to the microparticle films 3 and 5 and the organic compound films 4 and 6.
(2) Due to the microparticle films 3 and 5 having pores, a large amount of the functional molecules 7 can also be fixed inside the pores in the microparticle films 3 and 5 to enable the function of the composite thin film 1a to be improved by the large amount of fixed functional molecules 7 and further, excellent durability is provided because the fixed functional molecule 7 does not detach readily.

### Embodiment 3

FIG. 3 is a schematic view of an optical waveguide sensor according to Embodiment 3 of the present invention.

In FIG. 3, 11 is the optical waveguide sensor according to Embodiment 3, 12 is an optical waveguide made of an optical fiber, 13 is a core of the optical waveguide 12, 14 is a long period grating with a refractive index period of approximately 10 to 1500 μm formed on the core 13 of the optical waveguide 12, 15 is a cladding of the optical waveguide 12, 16 is a sensing film fixed to the cladding 15 at an outer side of the core 13 on which the long period grating 14 is formed, 17 is a microparticle film of the sensing film 16 formed on the surface of the cladding 15 by adsorption of microparticles, formed of an inorganic material, such as glass, quartz (silicon oxide), titanium oxide, silica gel, etc., a polymer material, such as polyacrylic acid, polyvinyl alcohol, cellulose, phenol resin, etc., a metal material, such as iron, silver, aluminum, silicon, etc., or a magnetic material, such as iron oxide, etc., to a substantially spherical shape with an average particle diameter of 10 to 100 nm and preferably 30 to 80 nm, and 18 is an organic compound film of the sensing film 16 formed by adsorption of an organic compound, such as a polystyrene sulfonic acid (PSS), polyvinyl sulfuric acid (PVS), dextran sulfuric acid (PSS), polyvinyl sulfuric acid (PVS), chondroitin sulfuric acid, polyacrylic acid (PAA), polymethacrylic acid (PMA), polymaleic acid, polyfumaric acid, polyethyleneimine (PEI), poly(allylamine hydrochloride) (PAH), poly(diallyldimethylammonium chloride) (PDDA), polyvinylpyridine (PVP), polylysine, etc., onto a surface of the microparticle film 17. The sensing film 16 is formed as a composite thin film in which the microparticle film 17 and the organic compound film 18 are laminated alternately once or a plurality of times.

A method for manufacturing the optical waveguide sensor according to Embodiment 3 with the arrangement described above shall now be described.

An intensity modulation mask, in which light transmitting portions and light shielding portions are aligned alternately at intervals corresponding to the period of the grating, is disposed on the optical waveguide 12, and ultraviolet light, etc., is irradiated to form a region (the long period grating 14) in which the refractive index is modulated at a period substantially equal to the period of alignment of the light transmitting portions on the core 13. Then, after introducing charges onto the surface of the cladding 15 by a means such as immersing the optical waveguide 12 in 2-aminoethanethiol, etc., the optical waveguide 12 is immersed in a dispersion of the microparticles having charges opposite those of the surface of the cladding 15 to make the microparticles be adsorbed on the optical waveguide 12 and thereby form the microparticle film 17. The optical waveguide 12 is then immersed in a solution of the organic compound having charges opposite those of the microparticles to make the organic compound be adsorbed on the surface of the microparticle film 17 formed on the optical waveguide 12 and thereby form the organic compound film 18. The lamination of the microparticle film 17 and the organic compound film 18 may performed alternately once or a plurality of times.

The following actions are provided by the optical waveguide sensor according to Embodiment 3 arranged as described above.

(1) The microparticle film 17 formed by adsorption of the microparticles on the optical waveguide 12 is in a state where a fine unevenness is formed on the surface by the adsorbed microparticles. The organic compound film 18 is formed by the adsorption of the organic compound on the surface of the microparticle film 17 on which the fine unevenness is formed, and thus in comparison to a case where the organic compound is formed on a smooth surface, the organic compound film 18 can be expanded in surface area and the number of reactive sites per single layer of the organic compound film 18 can be increased, thus making it possible to increase the sensitivity of the sensor.
(2) The number of reactive sites per single layer of the organic compound film 18 can be increased, thereby enabling the sensing film 16 of high sensitivity to be manufactured with a low number of laminations and thus with excellent productivity.
(3) The sensitivity is high and the response speed is high because comparatively large three-dimensional spaces (pores) that are continuous are formed between the microparticles of the microparticle film 17, and thus the molecular (chemical substance) diffusion property is excellent, molecules can be adsorbed rapidly onto the organic compound film 18 formed inside the three-dimensional spaces (pores), and desorbed molecules can be made to diffuse out of the sensing film 16 rapidly. Further, excellent applicability is provided in that molecules of high molecular weight can be detected because molecules of high molecular weight can also be adsorbed inside the three-dimensional spaces.
(4) The sensing film 16 can be formed by an alternate lamination method that makes use of electrostatic interaction, control of the manufacturing conditions is comparatively readily, and the sensing film 16 is flexible, is high in strength, and excellent in durability because aggregation and organization of the film are made to occur using electrostatic forces.
(5) The microparticles have an average particle diameter of 10 to 100 nm and preferably 30 to 80 nm, and thus continuous pores of suitable size can be formed between the microparticles of the microparticle film 17 to realize an excellent molecular diffusion property, extremely high sensitivity, and excellent responsivity.
(6) The LPG type optical waveguide sensor 11 in which the long period grating 14 is formed in the optical waveguide 12 is high in sensitivity with respect to the change of refractive index of the sensing film 16 and enables realization of high sensitivity and high response speed.

Here, although with the present embodiment, a case where the sensing film 16 is formed by laminating the microparticle film 17 and the organic compound film 18 alternately in that order on the optical waveguide 12 was described, in a case where the net charge of the solution of the organic compound is opposite the surface charge of the optical waveguide 12, the sensing film may be formed by laminating the organic compound film and the microparticle film alternately in that order on the optical waveguide 12. The same actions are provided in this case as well.

### Embodiment 4

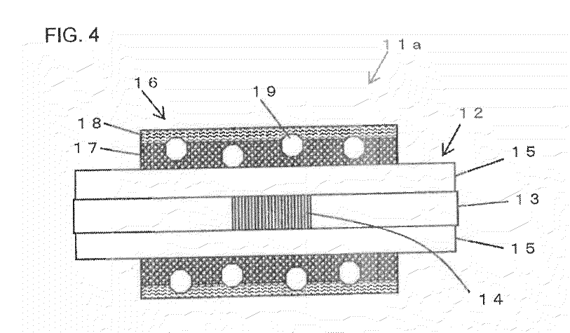

FIG. 4 is a schematic view of an optical waveguide sensor according to Embodiment 4 of the present invention. Moreover, portions that are the same as those of Embodiment 3 are provided with the same symbols and description thereof is omitted.

In FIG. 4, 11a is the optical waveguide sensor according to Embodiment 4, and 19 is a functional molecule, among glucose oxidase, hemoglobin, or other protein, deoxyribonucleic acid (DNA) or other nucleic acid, Mordant Yellow, or other functional dye, a polymer compound such as polysaccharides, cyclodextrins, porphyrins, polyacrylic acid, etc., or a metal microparticle, etc., and is fixed by an electrostatic interaction or a chemical reaction to the organic compound film 18 and the microparticle films 17.

A method for manufacturing the optical waveguide sensor according to Embodiment 4 with the arrangement described above shall now be described.

In the same manner as described in Embodiment 3, the microparticle film 17 and the organic compound film 18 are laminated alternately in that order on the optical waveguide 12 on which the long period grating 14 is formed. The optical waveguide 12 is then immersed in a solution or a dispersion of the functional molecule 19 having charges opposite those of the organic compound making up the organic compound film 18 to fix the functional molecule 19 by an electrostatic interaction to the organic compound film 8 and thereby manufacture the optical waveguide sensor 11a.

Or, after forming the sensing film 16 in the same manner as described in Embodiment 3 by laminating the microparticle film 17 and the organic compound film 18 alternately in that order on the optical waveguide 12 on which the long period grating 14 is formed, the sensing film 16 is immersed in a thiol solution to form a thiol compound film on the surface of the sensing film. Then, the optical waveguide sensor 11a may also be manufactured by an amino coupling method, etc., to fix a protein, complex antigen, or other functional molecule 19 via an amino group to a carboxyl group of the thiol compound by a chemical reaction. Besides using a thiol compound for fixing, the functional molecule 19 may also be fixed by an electrostatic interaction that makes use of surface charges and without using a thiol compound.

An example of a method for measuring an intermolecular interaction using the optical waveguide sensor according to Embodiment 4 shall now be described with reference to the drawings.

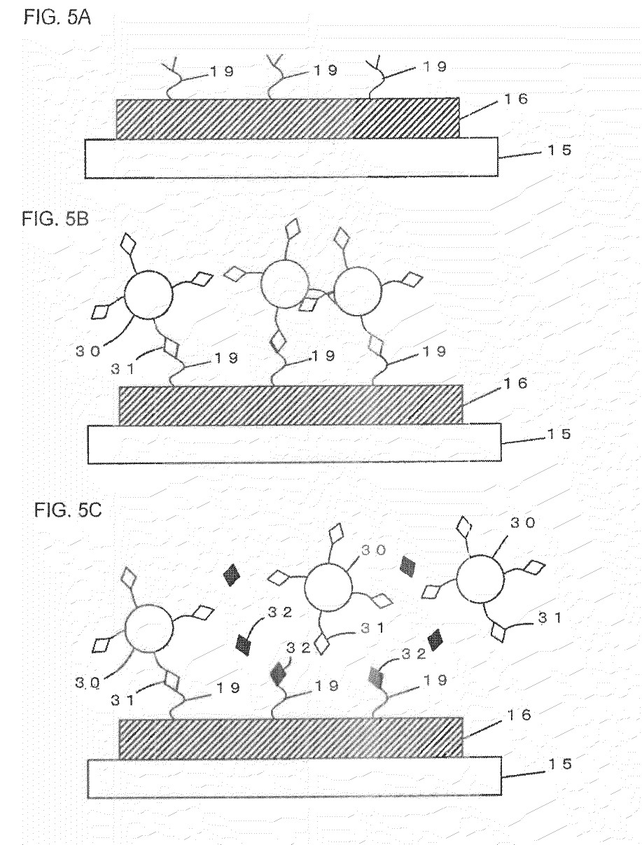

FIG. 5 shows schematic diagrams for explaining principles of the method for measuring intermolecular interactions using the optical waveguide sensor according to Embodiment 4. The intermolecular interaction measurement method described here is based on a displacement method.

With FIG. 5, a case where the functional molecule 19 is a polypeptide (antigen) or a complex antigen, in which a carrier protein, such as BSA (bovine serum albumin), OVA (ovalbumin), lactoprotein casein, KLH (keyhole limpet hemocyanin), thyroglobulin, etc., is bonded to a hapten, shall be described. The functional molecule 19 is fixed via an amino group of a peptide or not via an amino group but by an electrostatic interaction to the carboxyl group of the thiol compound film formed on the sensing film 16.

In FIG. 5, 30 is a carrier microparticle with an average particle diameter of 1 to several dozen nm formed of gold, silver, chromium, gallium, nickel, etc., and 31 is a monoclonal antibody fixed via a sulfur atom to a surface of the carrier microparticle 30. The monoclonal antibody 31 is an antibody capable of bonding by an antigen-antibody reaction to an antigen to be detected, which shall be described below, and the functional molecule 19 (antigen) fixed to the sensing film 16 and may be prepared using, as the immunogen, a complex antigen having the antigen to be detected, etc., as the hapten. The type of carrier protein to be used in preparing the complex antigen is not restricted in particular. Also, a commercially available antibody may be used as the monoclonal antibody 31. 32 is the antigen to be detected.

As shown in FIG. 5A, the functional molecule 19, which is a complex antigen or a polypeptide (antigen), is fixed to the sensing film 16 of the optical waveguide sensor 11a.

First, the sensing film 16 of the optical waveguide sensor 11a is immersed in a buffer solution containing the monoclonal antibody 31 to bond the monoclonal antibody 31 to the functional molecule 19 as shown in FIG. 5B. The carrier microparticle 30 is bonded via the monoclonal antibody 31 to the functional molecule 19. Although as the buffer solution, phosphate buffered saline (137 mM HCl, 8.1 mM NaHPO₄.12H₂O, 2.68 mM KCl, 1.47 mM KH₂PO₄, pH 7.2)/1% ethanol, 10 mM HEPES buffer (150 mM NaCl, 0.9 mM NaOH, 10 mM HEPES)/0.05% Tween 20, etc., may be used, the buffer solution is not restricted to these.

The unbonded monoclonal antibody 31 remaining on the optical waveguide sensor 11a is then rinsed off by a buffer solution that does not contain the monoclonal antibody 31, or the antigen 32, etc.

The sensing film 16 of the optical waveguide sensor 11a is then put in contact with a sample solution containing the antigen 32 to be detected. Then in accordance with a difference in bonding forces of the functional molecule 19 and the antigen 32 with respect to the monoclonal antibody 31, the monoclonal antibody 31 and the functional molecule 19 dissociate, and the carrier microparticle 30, which was bonded to the functional molecule 19 via the monoclonal antibody 31, also dissociates from the functional molecule 19 as shown in FIG. 5C. By dissociation of the carrier microparticle 30 from the functional molecule 19, the refractive index of the sensing film 16 changes and the intermolecular interaction can be detected by capturing this change of refractive index.

In addition to the actions described in Embodiment 3, the following actions are provided by the optical waveguide sensor according to Embodiment 4 arranged as described above.

(1) Excellent applicability is provided in that the sensitivity can be increased and selectivity can be expressed by increasing the refractive index, optical absorption coefficient, etc., of the sensing film 16 in accordance with the characteristics of the functional molecule 19 fixed to the microparticle film 17 and the organic compound film 18.
(2) Due to the microparticle films 17 having pores, a large amount of the functional molecules 19 can also be fixed inside the pores in the microparticle films 17 to enable the function of the sensing film 16 to be improved by the large amount of fixed functional molecules 19 and further, excellent long-term stability is provided because the fixed functional molecule 19 does not detach readily.
(3) Unlabeled detection of a specific bonding reaction between molecules can be performed in real time by monitoring the reaction in the form of change of refractive index of the sensing film 16. Bonding analysis of proteins, receptor/ligand assay, etc., can thus be performed at low cost in the same manner as in a surface plasmon resonance biosensor. In addition to analysis of protein interactions, application to analysis of DNA hybridization, cell response, etc., is also made possible by changing the type of the functional molecule 19.

Here, although with the present embodiment, a case where the sensing film 16 is formed by laminating the microparticle film 17 and the organic compound film 18 alternately in that order on the optical waveguide 12 was described, in a case where the net charge of the solution of the organic compound is opposite the surface charge of the optical waveguide 2, the sensing film may be formed by laminating the organic compound film and the microparticle film alternately in that order on the optical waveguide 2. The same actions are provided in this case as well.

### Embodiment 5

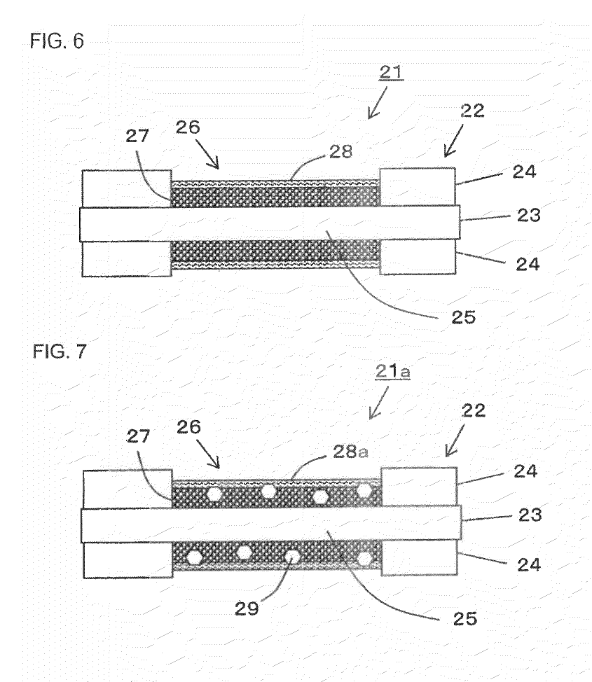

FIG. 6 is a schematic view of an optical waveguide sensor according to Embodiment 5 of the present invention.

In FIG. 6, 21 is the optical waveguide sensor according to Embodiment 5, 22 is an optical waveguide made of an optical fiber, 23 is a core of the optical waveguide 22, 24 is a cladding of the optical waveguide 22, 25 is a core-exposed portion at which a part of the core 23 is exposed by removing a part of the cladding 24, 26 is a sensing film formed on a surface of the core-exposed portion 25, 27 is a microparticle film of the sensing film 26 formed on the surface of the core-exposed portion 25 by adsorption of microparticles, formed of an inorganic material, such as glass, quartz (silicon oxide), titanium oxide, silica gel, etc., a polymer material, such as polyacrylic acid, polyvinyl alcohol, cellulose, phenol resin, etc., a metal material, such as iron, silver, aluminum, silicon, etc., or a magnetic material, such as iron oxide, etc., to a substantially spherical shape with an average particle diameter of 10 to 100 nm and preferably 30 to 80 nm, and 28 is an organic compound film of the sensing film 26 formed by an organic compound or metallo-organic complex, etc., having a ligand of one or a plurality of types among phthalocyanine derivatives, porphyrin derivatives, and pyridine derivatives, or a dye compound that is a complex system of a host compound, such as polysaccharides, dendrimer compounds, ethylenediamines, etc., and an organic dye that is cyanine-based, azlenium-based, pyrylium-based, squarylium-based, croconium-based, quinone/naphthoquinone-based, metal-complex-based, etc., adsorbed on a surface of the microparticle film 27. The sensing film 26 is formed as a composite thin film in which the microparticle film 27 and the organic compound film 28 are laminated alternately once or a plurality of times.

A method for manufacturing the optical waveguide sensor according to Embodiment 5 with the arrangement described above shall now be described.

First, the part of the cladding 24 of the optical waveguide 22 is dissolved by a chemical such as hydrogen fluoride, 1-4 dioxane, etc., melted by flame, or shaved off by a cutter, etc., to form the core-exposed portion 25. Then, after treating the core-exposed portion 25 with a potassium hydroxide solution, etc., to introduce charges on the surface of the core-exposed portion 5, the optical waveguide 22 is immersed in a dispersion of microparticles having charges that are opposite those of the surface of the core-exposed portion 25 to make the microparticles be adsorbed on the core-exposed portion 25 and form the microparticle film 27. The optical waveguide 22 is then immersed in a solution of the organic compound having charges opposite those of the microparticles to make the organic compound be adsorbed on the surface of the microparticle film 27 formed on the core-exposed portion 25 and thereby form the organic compound film 28. The lamination of the microparticle film 27 and the organic compound film 28 may performed alternately once or a plurality of times.

In addition to the actions described in Embodiment 3, the following action is provided by the optical waveguide sensor according to Embodiment 5 arranged as described above.

(1) A sensor of an evanescent absorption type in which the sensing film 26 is formed at the core-exposed portion 25 can be arranged, and because the sensitivity with respect to a change of optical absorption coefficient of the sensing film 26 is high, a sensor of high sensitivity and high response speed can be realized.

Here, although with the present embodiment, a case where the sensing film 26 is formed by laminating the microparticle film 27 and the organic compound film 28 alternately in that order on the core-exposed portion 25 was described, in a case where the net charge of the solution of the organic compound is opposite the surface charge of the core-exposed portion 25, the sensing film may be formed by laminating the organic compound film and the microparticle film alternately in that order on the core-exposed portion 25. The same actions are provided in this case as well.

### Embodiment 6

FIG. 7 is a schematic view of an optical waveguide sensor according to Embodiment 6 of the present invention. Moreover, portions that are the same as those of Embodiment 5 are provided with the same symbols and description thereof is omitted.

In FIG. 7, 21a is the optical waveguide sensor according to Embodiment 6, 28a is an organic compound film of the sensing film 26 formed of an organic compound, such as a polystyrene sulfonic acid (PSS), polyvinyl sulfuric acid (PVS), dextran sulfuric acid (PSS), polyvinyl sulfuric acid (PVS), chondroitin sulfuric acid, polyacrylic acid (PAA), polymethacrylic acid (PMA), polymaleic acid, polyfumaric acid, polyethyleneimine (PEI), poly(allylamine hydrochloride) (PAH), poly(diallyldimethylammonium chloride) (PDDA), polyvinylpyridine (PVP), polylysine, etc., and 29 is a functional molecule, such as an organic compound or metallo-organic complex, etc., having a ligand of one or a plurality of types among porphyrin derivatives, phthalocyanine derivatives, and pyridine derivatives, fixed by an electrostatic interaction to the sensing film 26.

A method for manufacturing the optical waveguide sensor according to Embodiment 6 with the arrangement described above shall now be described.

In the same manner as described in Embodiment 5, the microparticle film 27 and the organic compound film 28a are laminated alternately in that order on the optical waveguide 22 on which the core-exposed portion 25 is formed. The optical waveguide 22 is then immersed in a solution or a dispersion of the functional molecule 29 having charges opposite those of the organic compound making up the organic compound film 28a to fix the functional molecule 29 by an electrostatic interaction etc., to the organic compound film 28a and thereby manufacture the optical waveguide sensor 21a.

In addition to the actions described in Embodiment 5, the following actions are provided by the optical waveguide sensor according to Embodiment 6 arranged as described above.

(1) The organic compound or metallo-organic complex, etc., having a ligand of one or a plurality of types among porphyrin derivatives, phthalocyanine derivatives, and pyridine derivatives is high in an ability to adsorb water molecules and can thus increase the sensitivity as a humidity sensor, and further with these materials, hysteresis in humidification and dehumidification is unlikely to occur because capillary concentration of adsorbed water molecules is unlikely to occur, and thus humidity measurement of high precision can be performed with excellent reproducibility.
(2) Gas detection of high sensitivity and high precision can be performed even with a low number of laminations because porphyrin derivatives, phthalocyanine derivatives, pyridine derivatives, and metal complexes thereof are extremely high in absorption coefficient, exhibit stable redox characteristics, and the absorption band thus changes sensitively according to adsorption and desorption of molecules, and further because hysteresis is unlikely to occur. Also, a porphyrin derivative has a sharp absorption band near 400 to 500 nm called a Soret band, and an absorption band near 500 to 700 nm called a Q band, and because these overlap with near-ultraviolet and visible wavelengths, a compact sensor that makes use of near-ultraviolet and visible light can be manufactured.

Here, although with the present embodiment, a case where the sensing film 26 is formed by laminating the microparticle film 27 and the organic compound film 28a alternately in that order on the core-exposed portion 25 was described, in a case where the net charge of the solution of the organic compound is opposite the surface charge of the core-exposed portion 25, the sensing film may be formed by laminating the organic compound film and the microparticle film alternately in that order on the core-exposed portion 25. The same actions are provided in this case as well.

Also, although a case where the organic compound film 28a is formed of poly(allylamine hydrochloride) (PAH), etc., was described, alizarin yellow, methyl red, thymol blue, or other dye compound that is sultone-based, diazo-based, cyanine-based, azlenium-based, pyrylium-based, squarylium-based, croconium-based, quinone/naphthoquinone-based, or metal-complex-based, etc., may be used. A bandwidth of the light absorption band can thereby be widened or the amount of change of absorptivity in the light absorption band can be increased to heighten the detection sensitivity.

### EXAMPLES

The atmosphere sensor having the composite thin film according to the present invention shall now be described specifically by way of experimental examples. However, the present invention is not restricted to these experimental examples.

### Experimental Example 1

A piezoelectric substrate (quartz oscillator) having a normal frequency of 9 MHz and having electrodes made of gold formed on both surfaces was used as the support. After subjecting the support to a pirana (H₂SO₄:H₂O₂=3:1) treatment, the support was immersed for 12 hours in an ethanol solution of mercaptoethanol (10 mmol/L) to perform hydroxyl group modification of the electrode surfaces of the support. After rinsing adequately with ethanol and ion-exchanged water, drying was performed by blowing on nitrogen gas, and charges (anionic) were thus introduced by the hydroxyl group modification of the surfaces of the support.

The support was then immersed for 20 minutes in a 0.1 wt % aqueous solution of poly(allylamine hydrochloride) (cationic, made by Sigma-Aldrich Corp., weight average molecular weight: 70000). The support was then immersed for 1 minute in ion-exchanged water to rinse off an excess adsorbed portion and dried with nitrogen gas to form organic compound films of poly(allylamine hydrochloride) on the surfaces of the support.

The support was then immersed for 10 to 20 minutes in a 20 to 21 wt % aqueous solution of a silica sol (Snowtex 20, particle diameter: 10 to 20 nm, pH: 9.5 to 10.0, Na stabilized, anionic, made by Nissan Chemical Industries Ltd.). The support was then immersed for 1 minute in ion-exchanged water to rinse off the excess adsorbed portion and dried with nitrogen gas to form microparticle films with which silica microparticles are adsorbed on surfaces of the organic compound films.

The support was then immersed for 20 minutes in a 0.1 wt % aqueous solution (pH: 10 to 11, 30° C.) of poly(allylamine hydrochloride) (cationic, made by Sigma-Aldrich Corp., weight average molecular weight: 70000). The support was then immersed for 1 minute in ion-exchanged water to rinse off the excess adsorbed portion and dried with nitrogen gas to form organic compound films of poly(allylamine hydrochloride) on surfaces of the microparticle films.

The formation of the microparticle films and the organic compound films was performed repeatedly by the same method to obtain an atmosphere sensor of Experimental Example 1 in which ten layers each of the microparticle film and the organic compound film are laminated.

### Experimental Example 2

Besides forming the microparticle films by immersing the support in a 20 to 21 wt % aqueous solution of a silica sol (Snowtex 20 L, particle diameter: 40 to 50 nm, pH: 9.5 to 11.0, Na stabilized, anionic, made by Nissan Chemical Industries Ltd.) in the process of forming the microparticle films, an atmosphere sensor of Experimental Example 2 was obtained in the same manner as in Experimental Example 1.

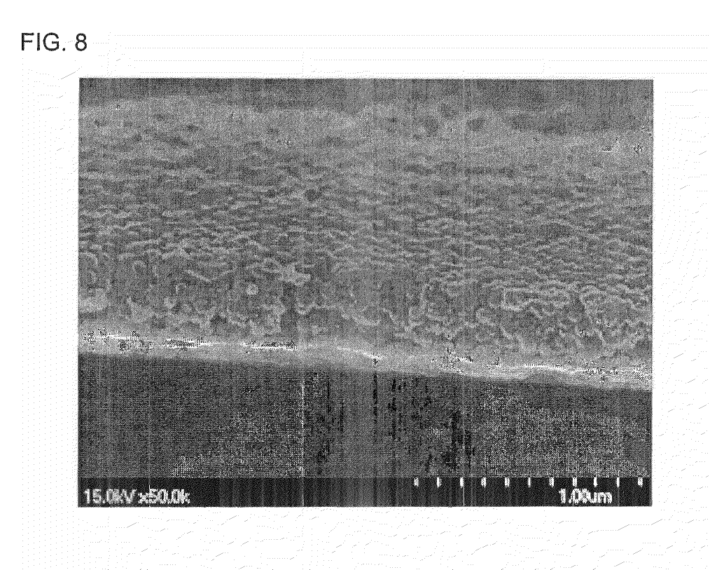

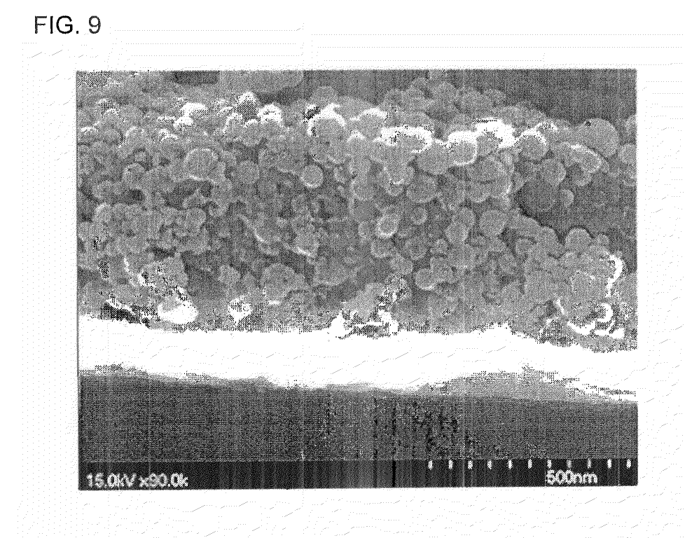

FIG. 8 is an SEM photograph of a surface and a fracture section of the composite thin film of the atmosphere sensor of Experimental Example 2, and FIG. 9 is an SEM photograph of a fracture section of the atmosphere sensor of Experimental Example 2. The composite thin film of the atmosphere sensor of Experimental Example 2 has a thickness of approximately 500 nm and it is understood that pores are formed between the microparticles of the composite thin film.

### Experimental Example 3

Besides forming the microparticle films by immersing the support in a 40 to 41 wt % aqueous solution of a silica sol (Snowtex YL, particle diameter: 50 to 80 nm, pH: 9.0 to 10.0, Na stabilized, anionic, made by Nissan Chemical Industries Ltd.) in the process of forming the microparticle films, an atmosphere sensor of Experimental Example 3 was obtained in the same manner as in Experimental Example 1.

### Experimental Examples 4 to 6

The atmosphere sensor obtained in Experimental Example 1 was immersed for 12 hours in an aqueous solution (approximately 1 mM) of sodium β-cyclodextrin sulfate (β-CD, CAS No.: 37191-69-8, made by Sigma-Aldrich Corp.) as a functional molecule to obtain an atmosphere sensor of Experimental Example 4.

Likewise, the atmosphere sensor obtained in Experimental Example 2 was immersed for 12 hours in an aqueous solution (approximately 1 mM) of sodium β-cyclodextrin sulfate (β-CD, CAS No.: 37191-69-8, made by Sigma-Aldrich Corp.) as a functional molecule to obtain an atmosphere sensor of Experimental Example 5. Also likewise, the atmosphere sensor obtained in Experimental Example 3 was immersed for 12 hours in an aqueous solution (approximately 1 mM) of sodium β-cyclodextrin sulfate (β-CD, CAS No.: 37191-69-8, made by Sigma-Aldrich Corp.) as a functional molecule to obtain an atmosphere sensor of Experimental Example 6.

In obtaining each of the atmosphere sensors of Experimental Examples 4 to 6, a change of frequency of the quartz oscillator was measured by a QCM (quartz crystal microbalance) at each predetermined time from a start of immersion of each of the atmosphere sensors of Experimental Examples 1 to 3 in the aqueous solution to measure a time variation of an amount of adsorption of the functional molecule onto the composite thin film.

### Experimental Examples 7 to 9

The atmosphere sensors of Experimental Examples 1 to 3 were respectively immersed for 12 hours in a 1 mM aqueous solution of tetrakis(sulfophenyl)porphyrin (TSPP, molecular weight Mr=934.99, made by Tokyo Chemical Industry Co., Ltd.) as a functional molecule to correspondingly obtain atmosphere sensors of Experimental Examples 7 to 9 in the same manner as described above. In obtaining each of the atmosphere sensors of Experimental Examples 7 to 9, the change of frequency of the quartz oscillator was measured by the QCM (quartz crystal microbalance) at each predetermined time from the start of immersion of each of the atmosphere sensors of Experimental Examples 1 to 3 in the aqueous solution to measure the time variation of the amount of adsorption of the functional molecule onto the composite thin film.

### Experimental Examples 10 to 12

The atmosphere sensors of Experimental Examples 1 to 3 were respectively immersed for 12 hours in a 1 mM aqueous solution of a manganese complex of tetrakis(sulfophenyl)porphyrin (Mn-TSPP, molecular weight Mr=1023.36, made by Sigma-Aldrich Corp.) as a functional molecule to correspondingly obtain atmosphere sensors of Experimental Examples 10 to 12 in the same manner as described above. In obtaining each of the atmosphere sensors of Experimental Examples 10 to 12, the change of frequency of the quartz oscillator was measured by the QCM (quartz crystal microbalance) at each predetermined time from the start of immersion of each of the atmosphere sensors of Experimental Examples 1 to 3 in the aqueous solution to measure the time variation of the amount of adsorption of the functional molecule onto the composite thin film.

### Experimental Examples 13 to 15

The atmosphere sensors of Experimental Examples 1 to 3 were respectively immersed for 12 hours in a 0.05 wt % aqueous solution of polyacrylic acid (PAA₄₀₀, molecular weight Mr=4000000, made by Sigma-Aldrich Corp.) as a functional molecule to correspondingly obtain atmosphere sensors of Experimental Examples 13 to 15 in the same manner as described above. In obtaining each of the atmosphere sensors of Experimental Examples 13 to 15, the change of frequency of the quartz oscillator was measured by the QCM (quartz crystal microbalance) at each predetermined time from the start of immersion of each of the atmosphere sensors of Experimental Examples 1 to 3 in the aqueous solution to measure the time variation of the amount of adsorption of the functional molecule onto the composite thin film.

### Experimental Examples 16 to 18

The atmosphere sensors of Experimental Examples 1 to 3 were respectively immersed for 12 hours in a 0.1 wt % aqueous solution of polyacrylic acid (PAA₂₅, molecular weight Mr=250000, made by Sigma-Aldrich Corp.) as a functional molecule to correspondingly obtain atmosphere sensors of Experimental Examples 16 to 18 in the same manner as described above. In obtaining each of the atmosphere sensors of Experimental Examples 16 to 18, the change of frequency of the quartz oscillator was measured by the QCM (quartz crystal microbalance) at each predetermined time from the start of immersion of each of the atmosphere sensors of Experimental Examples 1 to 3 in the aqueous solution to measure the time variation of the amount of adsorption of the functional molecule onto the composite thin film.

### Comparative Example 1

An atmosphere sensor of Comparative Example 1 was manufactured by the following method described in WO2007/114192 (Patent Document 1).

First, a piezoelectric substrate (quartz oscillator) having a normal frequency of 9 MHz and having electrodes made of gold formed on both surfaces was used as the support. After subjecting the support to a pirana (H₂SO₄:H₂O₂=3:1) treatment, the support was immersed for 12 hours in an ethanol solution of mercaptoethanol (10 mmol/L) to perform hydroxyl group modification of the electrode surfaces of the support. After rinsing adequately with ethanol and ion-exchanged water, drying was performed by blowing on nitrogen gas, and charges (anionic) were thus introduced by the hydroxyl group modification of the surfaces of the support.

Next, while keeping 10 to 20 mL of titanium butoxide (Ti(O-nBu)₄) (made by Kishida Chemical Co., Ltd.), which is a metal oxide precursor, at 85° C. in a constant temperature bath with a stirring apparatus, nitrogen gas was blown in at a flow rate 3 L/minute to generate a titanium butoxide vapor, and using nitrogen gas (transfer medium), the generated titanium butoxide vapor was transferred to and put in contact with surfaces of the substrate for 10 minutes to form metal oxide precursor adsorption layers on the surfaces of the support. Thereafter, just the nitrogen gas (transfer medium) was blown adequately onto the metal oxide precursor adsorption layers to remove weakly physically adsorbed species, that is, the excess metal oxide precursor.

The metal oxide precursor adsorption layers were then hydrolyzed by ion-exchanged water to form metal oxide films and thereafter, drying was performed by blowing on nitrogen gas.

The support with the metal oxide films formed thereon was then immersed for 20 minutes in a 0.1 wt % aqueous solution of polyacrylic acid (PAA₂₅, molecular weight Mr=250000, made by Sigma-Aldrich Corp.). The support was then immersed for 1 minute in ion-exchanged water to rinse off the excess adsorbed portion and dried with nitrogen gas to form organic compound films of polyacrylic acid on the surfaces of the metal oxide films.

The alternate lamination of the metal oxide films and the organic compound films were performed repeatedly by the same method to obtain an atmosphere sensor of Comparative Example 1 in which ten layers each of the metal oxide film and the organic compound film are laminated on the support.

### Comparative Example 2

Besides immersing the support, with the metal oxide films formed thereon, in a 0.05 wt % aqueous solution of polyacrylic acid (PAA₄₀₀, molecular weight Mr=4000000, made by Sigma-Aldrich Corp.) in the process of forming the organic compound films, an atmosphere sensor of Comparative Example 2 was obtained in the same manner as in Comparative Example 1.

### Comparative Example 3

Besides immersing the support, with the metal oxide films formed thereon, in a 0.1 wt % aqueous solution of poly(allylamine hydrochloride) (PAH, molecular weight Mr=70000, made by Sigma-Aldrich Corp.) in the process of forming the organic compound films, an atmosphere sensor of Comparative Example 3 was obtained in the same manner as in Comparative Example 1.

(Time Variation of Adsorption Amount of Functional Molecule)

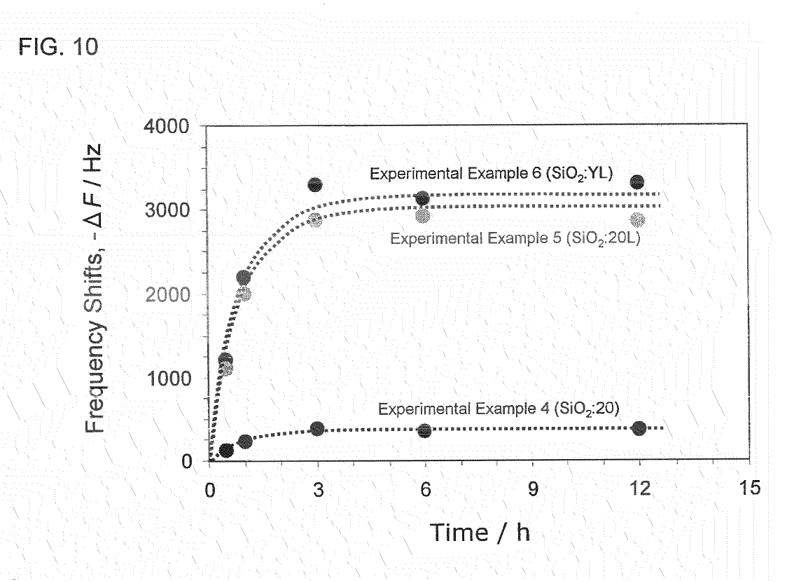

FIG. 10 is a diagram of time variations of adsorption amounts of the functional molecule β-CD in the atmosphere sensors of Experimental Examples 4 to 6. The abscissa indicates immersion time in the β-CD aqueous solution, and the ordinate indicates change of frequency of the quartz oscillator. A greater change of frequency of the quartz oscillator indicates a larger adsorption amount of the functional molecule.

As shown in FIG. 10, the frequency change saturates at approximately 3 hours, and it was found that the frequency changes of the atmosphere sensors in Experimental Examples 5 and 6 were large in comparison to the frequency change of the atmosphere sensor in Experimental Example 4. In the atmosphere sensor of Experimental Example 5, the microparticle films are formed of microparticles with a particle diameter of 40 to 50 nm, and in the atmosphere sensor of Experimental Example 6, the microparticle films are formed of microparticles with a particle diameter of 50 to 80 nm. In contrast, in the atmosphere sensor of Experimental Example 4, the microparticle films are formed of microparticles with a particle diameter of 10 to 20 nm. The difference in the adsorption amount of the functional molecule indicates that porosities of the microparticle films formed of the microparticles of 40 to 50 nm particle diameter and 50 to 80 nm particle diameter are greater than the porosities of the microparticle films formed of the microparticles of 10 to 20 nm particle diameter.

It was confirmed that likewise in the atmosphere sensors of Experimental Examples 7 to 18, the frequency changes in the atmosphere sensors having the microparticle films formed of the microparticles of 40 to 50 nm particle diameter and 50 to 80 nm particle diameter are large in comparison to the frequency changes in the atmosphere sensors having the microparticle films formed of the microparticles of 10 to 20 nm particle diameter.

From these experiments, it was inferred that the microparticle films formed of the microparticles of 40 to 50 nm particle diameter and 50 to 80 nm particle diameter are greater in porosity than the microparticle films formed of the microparticles of 10 to 20 nm particle diameter and can thus fix a larger amount of the functional molecules.

(Response of Atmosphere Sensors to Ammonia)

Gas responsivities of the atmosphere sensors with respect to ammonia were measured. First, each atmosphere sensor was disposed inside a flow cell and thereafter, air (blank gas) was made to flow through the flow cell at 1 L/minute and a change of a characteristic frequency of the quartz oscillator was measured as a baseline of the atmosphere sensor.

Ammonia gases of concentrations of 0.1 ppm, 0.5 ppm, 1 ppm, 3 ppm, 5 ppm, 10 ppm, 30 ppm, and 100 ppm, respectively, were then made to flow through the flow cell at 1 L/minute, and the changes of the characteristic frequency of the quartz oscillator were measured by the QCM. The measurements were made with the flow cell being maintained 25° C.

Moreover, after an ammonia gas of fixed concentration was made to flow through the flow cell and the response of the atmosphere sensor was measured, an adequate amount of air (blank gas) was made to flow through the flow cell to return the characteristic frequency of the quartz oscillator to the initial state.

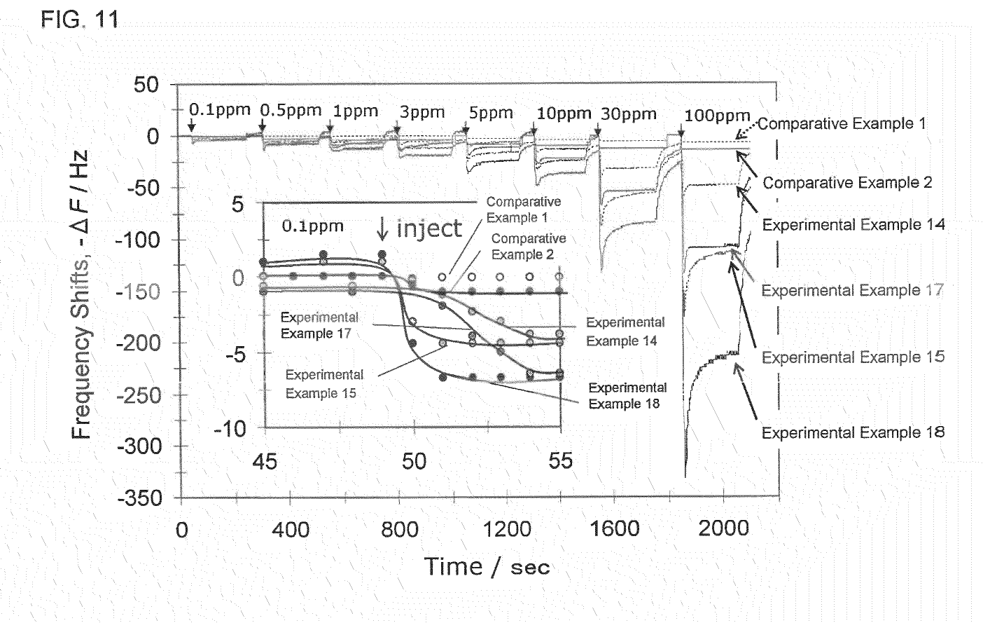

FIG. 11 is a diagram in which time response characteristics of the frequency changes of the atmosphere sensors of Experimental Examples 14, 15, 17, and 18 and Comparative Examples 1 and 2 are plotted according to ammonia gas concentration.

From FIG. 11, it was found that the atmosphere sensors of Experimental Examples 14, 15, 17, and 18 are significantly large in frequency change in comparison to the atmosphere sensors of Comparative Examples 1 and 2, and significantly better in gas responsivity. In particular, it was found that with the atmosphere sensors of Experimental Examples 15 and 18, in which the functional molecule (polyacrylic acid) is fixed upon forming the microparticle films using the microparticles of 50 to 80 nm particle diameter, a frequency change occurs approximately 1 second after the introduction of a minute amount of gas of 0.1 ppm and that a dilute ammonia gas of a ppb order can be detected with high sensitivity.

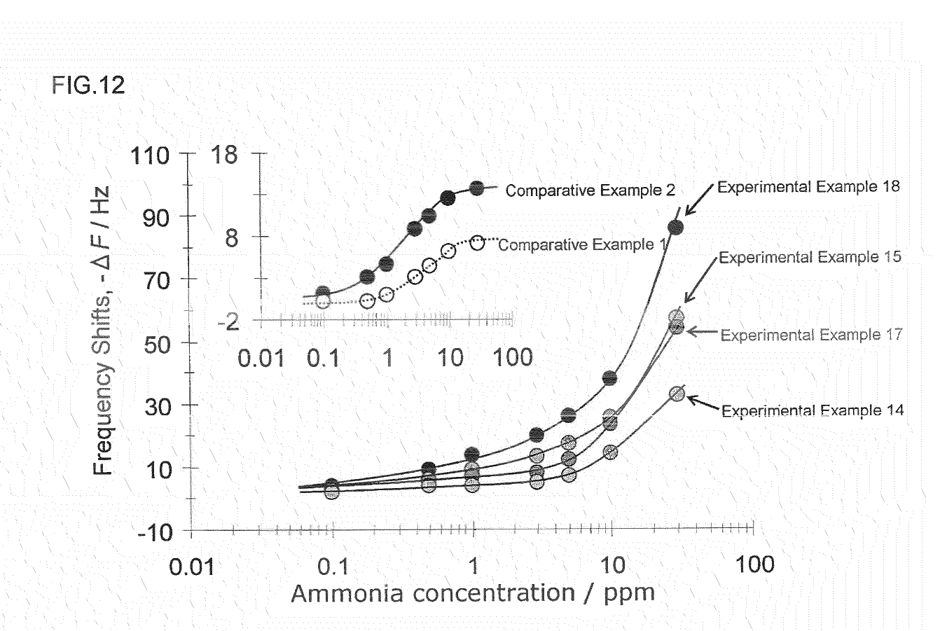

FIG. 12 is a diagram, showing for the atmosphere sensors of Experimental Examples 14, 15, 17, and 18 and Comparative Examples 1 and 2, relationships of the frequency change and ammonia concentration at 20 seconds after making ammonia gas flow into the flow cell in the cases of Comparative Examples 1 and 2 and at equilibrium after making ammonia gas flow into the flow cell in the cases of Experimental Examples 14, 15, 17, and 18.

From FIG. 12, it was found that whereas with the atmosphere sensors of Comparative Examples 1 and 2, the frequency change saturates when the gas concentration is no less than 10 ppm, with the atmosphere sensors of Experimental Examples 14, 15, 17, and 18, a frequency change occurs without saturation even when the gas concentration is no less than 10 ppm. Consequently, it was confirmed that the atmosphere sensors of Experimental Examples 14, 15, 17, and 18 are capable of detecting gases of a low concentration of approximately 0.1 ppm to a high concentration of no less than 10 ppm and are thus excellent in applicability.

(Response of Atmosphere Sensors to Aniline)

Gas responsivities of the atmosphere sensors with respect to aniline were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Aniline gases of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

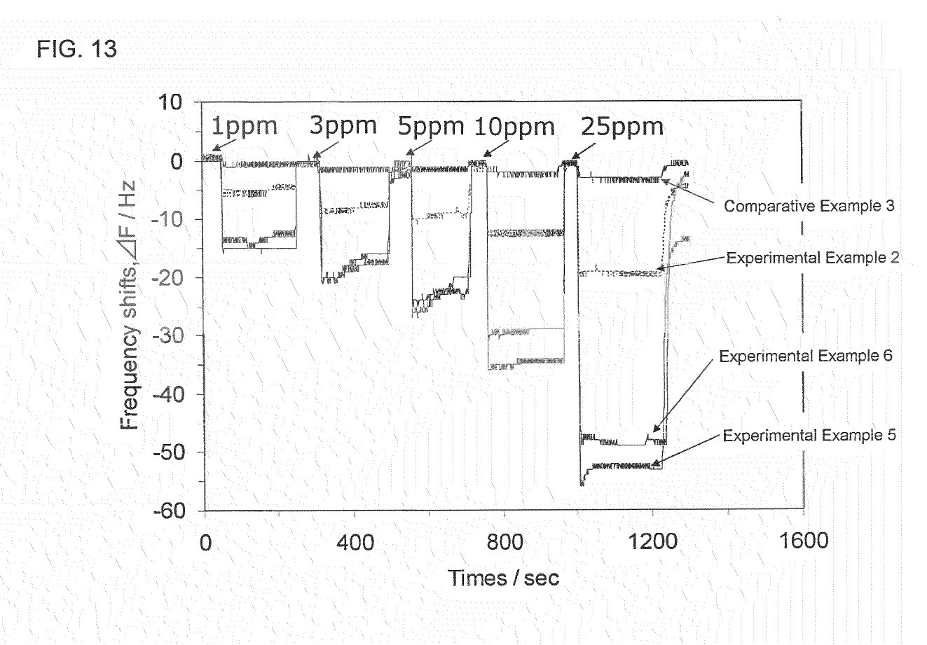

FIG. 13 is a diagram in which the time response characteristics of the frequency changes of atmosphere sensors of Experimental Examples 2, 5, and 6 and Comparative Example 3 are plotted according to aniline gas concentration.

From FIG. 13, it was found that the atmosphere sensors of Experimental Examples 2, 5, and 6 are significantly large in frequency change in comparison to the atmosphere sensor of Comparative Example 3, and significantly better in gas responsivity. In particular, it was found that with the atmosphere sensors of Experimental Examples 5 and 6, in which the functional particles (β-CD) are fixed, the frequency change is large and the sensitivity is high.

(Response of Atmosphere Sensors to Pyridine)

Gas responsivities of the atmosphere sensors with respect to pyridine were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Aniline gases of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

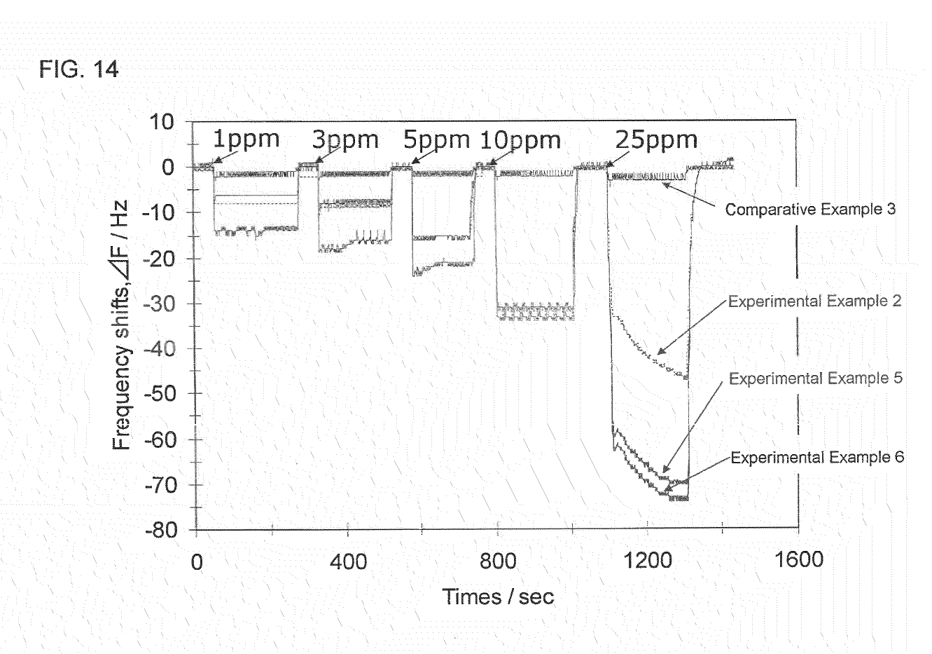

FIG. 14 is a diagram in which the time response characteristics of the frequency changes of atmosphere sensors of Experimental Examples 2, 5, and 6 and Comparative Example 3 are plotted according to pyridine gas concentration.

From FIG. 14, it was found that the atmosphere sensors of Experimental Examples 2, 5, and 6 are significantly large in frequency change in comparison to the atmosphere sensor of Comparative Example 3, and significantly better in gas responsivity. In particular, it was found that with the atmosphere sensors of Experimental Examples 5 and 6, in which the functional particles (β-CD) are fixed, the frequency change is large and the sensitivity is high.

(Response of Atmosphere Sensors to Benzene)

Gas responsivities of the atmosphere sensors with respect to benzene were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Benzene gases of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the WM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

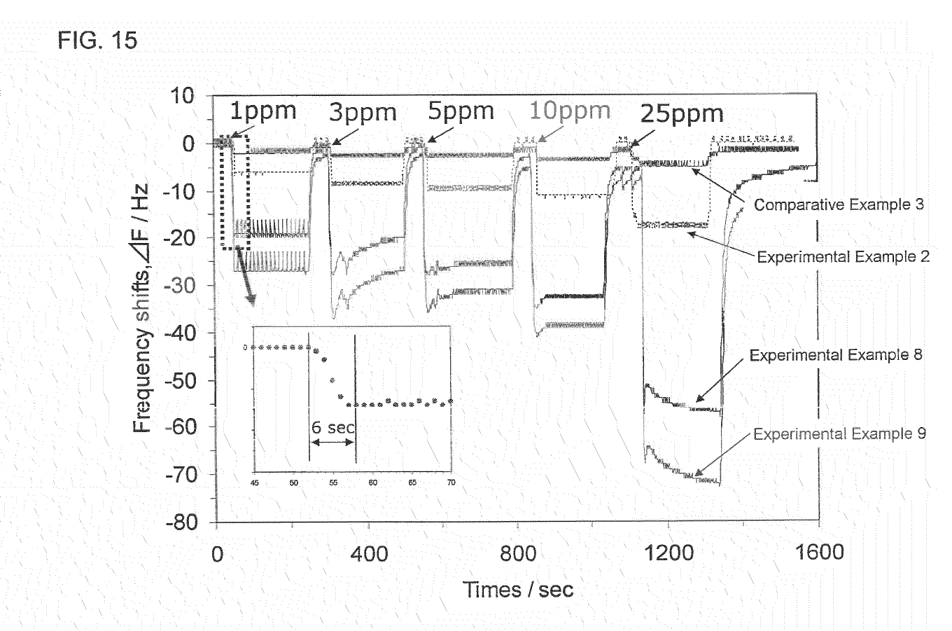

FIG. 15 is a diagram in which the time response characteristics of the frequency changes of atmosphere sensors of Experimental Examples 2, 8, and 9 and Comparative Example 3 are plotted according to benzene gas concentration.

From FIG. 15, it was found that in comparison to the atmosphere sensor of Comparative Example 3, the frequency change is significantly large, saturation is reached in approximately 6 seconds from the introduction of the gas when the concentration is 1 ppm, and the gas responsivity is significantly better with the atmosphere sensors of Experimental Examples 2, 8, and 9. It was found that, among them with the atmosphere sensors of Experimental Examples 8 and 9 in which the functional particles (TSPP) are fixed, in particular, with the atmosphere sensor of Experimental Example 9, having the microparticle film formed of the microparticles of 50 to 80 nm particle diameter, the frequency change is large and the sensitivity is high.

(Response of Atmosphere Sensors to Toluene)

Gas responsivities of the atmosphere sensors with respect to toluene were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Toluene gases of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

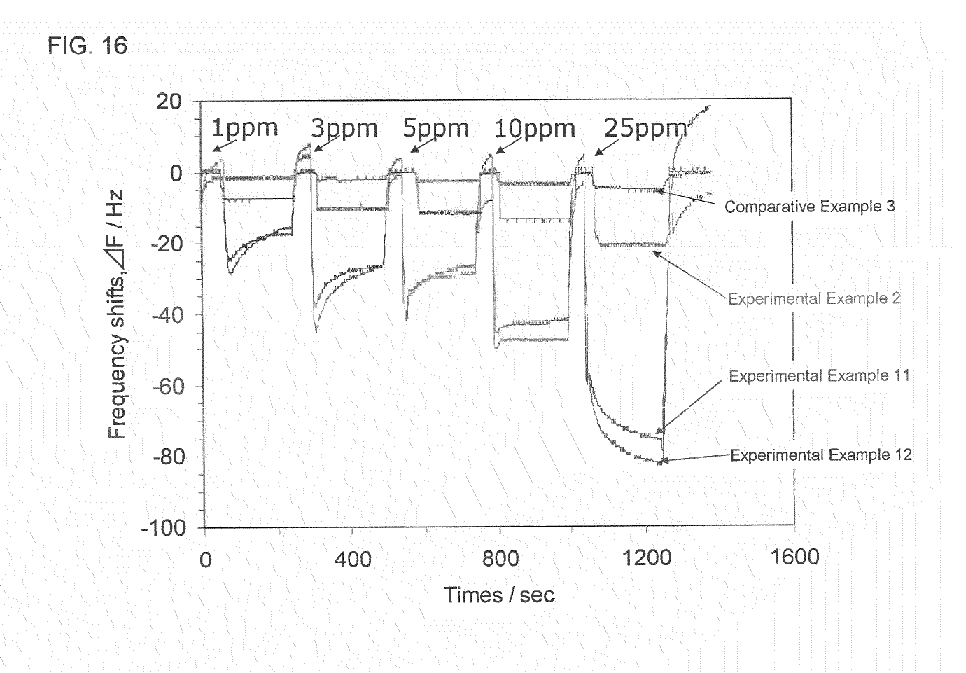

FIG. 16 is a diagram in which the time response characteristics of the frequency changes of atmosphere sensors of Experimental Examples 2, 11, and 12 and Comparative Example 3 are plotted according to toluene gas concentration.

From FIG. 16, it was found that the atmosphere sensors of Experimental Examples 2, 11, and 12 are significantly large in frequency change in comparison to the atmosphere sensor of Comparative Example 3, and significantly better in gas responsivity. In particular, it was found that with the atmosphere sensors of Experimental Examples 11 and 12, in which the functional particles (Mn-TSPP) are fixed, the frequency change is large and the sensitivity is high.

(Response of Atmosphere Sensors to p-Xylene)

Gas responsivities of the atmosphere sensors with respect to p-xylene were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

P-xylene gases of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

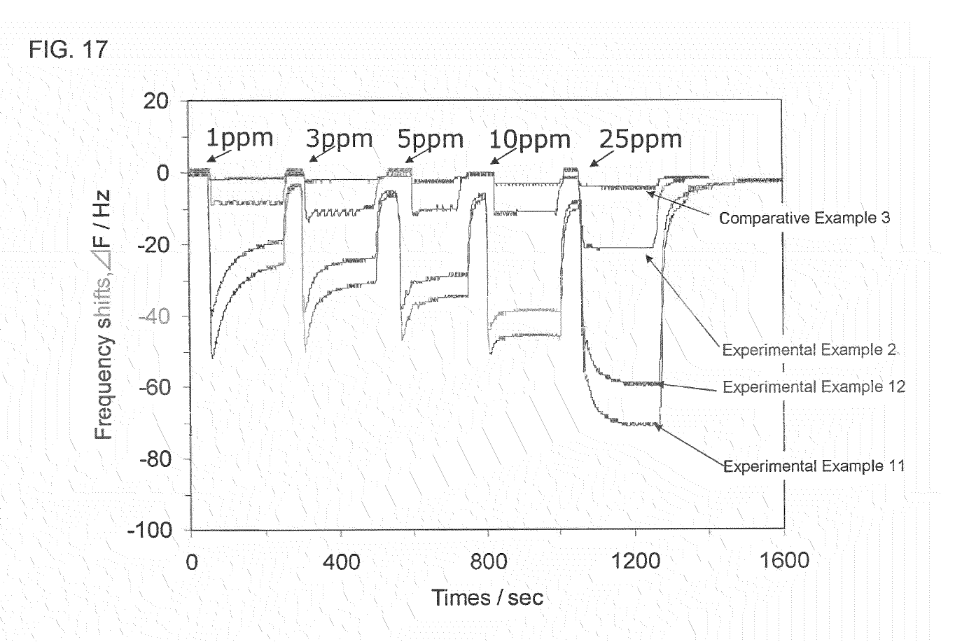

FIG. 17 is a diagram in which the time response characteristics of the frequency changes of atmosphere sensors of Experimental Examples 2, 11, and 12 and Comparative Example 3 are plotted according to p-xylene gas concentration.

From FIG. 17, it was found that the atmosphere sensors of Experimental Examples 2, 11, and 12 are significantly large in frequency change in comparison to the atmosphere sensor of Comparative Example 3, and significantly better in gas responsivity. In particular, it was found that with the atmosphere sensors of Experimental Examples 11 and 12, in which the functional particles (Mn-TSPP) are fixed, the frequency change is large and the sensitivity is high.

(Response of Atmosphere Sensors to Acetaldehyde)

Gas responsivities of the atmosphere sensors with respect to acetaldehyde were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Acetaldehyde of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

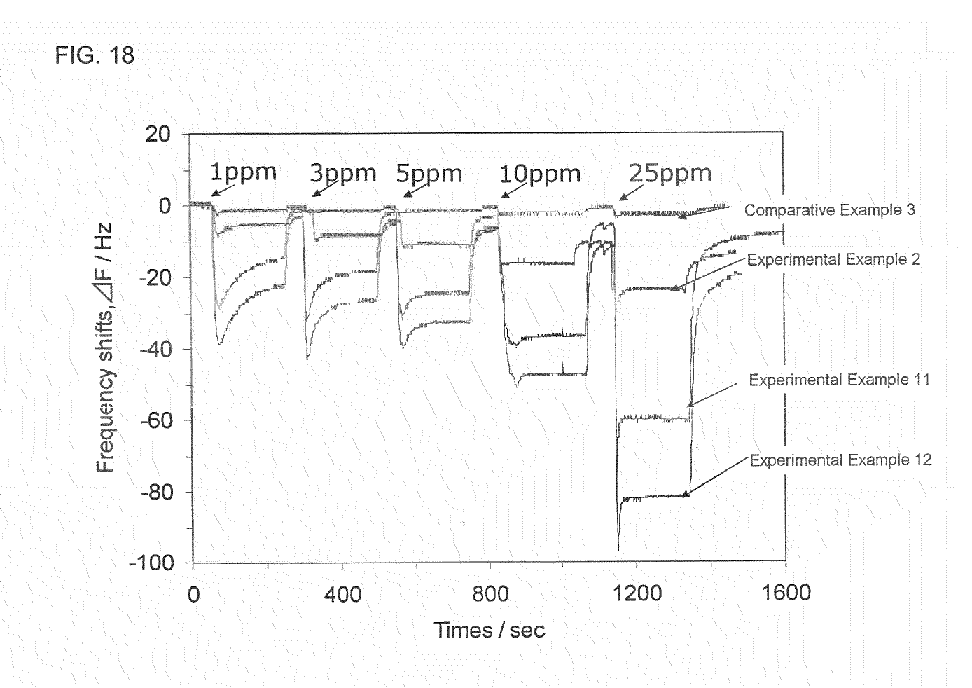

FIG. 18 is a diagram in which the time response characteristics of the frequency changes of atmosphere sensors of Experimental Examples 2, 11, and 12 and Comparative Example 3 are plotted according to acetaldehyde gas concentration.

From FIG. 18, it was found that the atmosphere sensors of Experimental Examples 2, 11, and 12 are significantly large in frequency change in comparison to the atmosphere sensor of Comparative Example 3, and significantly better in gas responsivity. In particular, it was found that with the atmosphere sensors of Experimental Examples 11 and 12, in which the functional particles (Mn-TSPP) are fixed, the frequency change is large and the sensitivity is high.

(Response of Atmosphere Sensors to Cyclohexane)

Gas responsivities of the atmosphere sensors with respect to cyclohexane were measured. First, each atmosphere sensor was disposed inside a flow cell and thereafter, air (blank gas) was made to flow through the flow cell at 1 L/minute and the change of the characteristic frequency of the quartz oscillator was measured as the baseline of the atmosphere sensor.

Cyclohexane of concentrations of 1 ppm, 3 ppm, 5 ppm, 10 ppm, and 25 ppm, respectively, were then made to flow through the flow cell at 1 L/minute, and the changes of the characteristic frequency of the quartz oscillator were measured by the QCM. The measurements were made with the flow cell being maintained 25° C.

Moreover, after measuring the response of the atmosphere sensor, an adequate amount of air (blank gas) was made to flow through the flow cell to return the characteristic frequency of the quartz oscillator to the initial state.

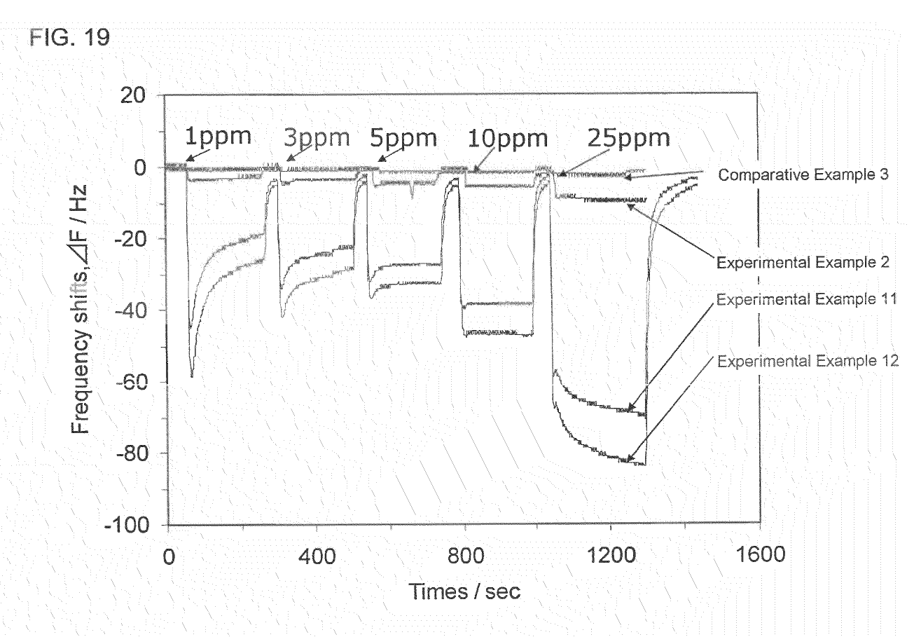

FIG. 19 is a diagram in which the time response characteristics of the frequency changes of atmosphere sensors of Experimental Examples 2, 11, and 12 and Comparative Example 3 are plotted according to cyclohexane gas concentration.

From FIG. 19, it was found that the atmosphere sensors of Experimental Examples 2, 11, and 12 are significantly large in frequency change in comparison to the atmosphere sensor of Comparative Example 3, and significantly better in gas responsivity. In particular, it was found that with the atmosphere sensors of Experimental Examples 11 and 12, in which the functional particles (Mn-TSPP) are fixed, the frequency change is large and the sensitivity is high.

As described above, it was confirmed that atmosphere sensors that are high in detection sensitivity and excellent in responsivity can be provided by the present examples. It was also made clear that the detection sensitivity to a specific type of gas can be improved dramatically according to the type of functional molecule modifying the organic compound films or the microparticle films. These significant effects are realized by the formation of large three-dimensional spaces of excellent diffusion property in the microparticle films and the organic compound films by the pores formed in the microparticle films.

It was also confirmed by the present examples that even a polymer such as polyacrylic acid (molecular weight Mr=4000000) can diffuse in the three-dimensional spaces formed in the microparticle films and the organic compound films. It is thus clear that polymers, such as proteins and nucleic acids, can diffuse through the microparticle films and the organic compound films and modify the microparticle films and the organic compound films. The composite thin films of the present examples can thus be said to be widely applicable not only to atmosphere sensors, such as gas sensors, humidity sensors, etc., but also to biosensors, such as immunoassay sensors, and new molecular devices, such as enzyme reactors, light emitting devices, etc.

The optical waveguide sensor having the composite thin film according to the present invention shall now be described specifically by way of experimental examples. However, the present invention is not restricted to these experimental examples.

### Experimental Example 19

As an optical waveguide, a single-mode optical fiber (SM750, cutoff wavelength: 670 nm), with which a long period grating with a refractive index period of 100 μm is formed to a length of 30 mm, was used. The part of the optical waveguide in which the long period grating is formed was rinsed adequately with ion-exchanged water and then immersed for 20 minutes in a 1 wt % ethanol solution (ethanol:water=3:2, v/v) of potassium hydroxide to perform hydroxyl group modification of the cladding of the optical waveguide. After rinsing adequately with ethanol and ion-exchanged water, drying was performed by blowing on nitrogen gas, and charges (anionic) were thus introduced by the hydroxyl group modification of the surface of the optical waveguide.

The optical waveguide was then immersed for 20 minutes in a 0.5 wt % aqueous solution of poly(diallyldimethylammonium chloride) (PDDA, cationic, weight average molecular weight: 200000-350000, made by Tokyo Chemical Industry Co., Ltd.). The optical waveguide was then immersed for 1 minute in ion-exchanged water to rinse off the excess adsorbed portion and dried with nitrogen gas to form an organic compound film of poly(diallyldimethylammonium chloride) (PDDA) on the surface of the optical waveguide.

The optical waveguide was then immersed for 20 minutes in a 20 to 21 wt % aqueous solution of a silica sol (Snowtex20 L, particle diameter: 40 to 50 nm, anionic, made by Nissan Chemical Industries Ltd.). The optical waveguide was then immersed for 1 minute in ion-exchanged water to rinse off the excess adsorbed portion and dried with nitrogen gas to form a microparticle film with which silica microparticles are adsorbed on the surface of the organic compound film.

The formation of the microparticle film and the organic compound film was performed repeatedly by the same method to obtain an optical waveguide sensor having the sensing film of Experimental Example 1 in which ten layers each of the microparticle film and the organic compound film are laminated. A thickness of the sensing film of Experimental Example 1 was 450 nm. The particle diameter of the microparticles was 40 to 50 nm, and because the thickness of the sensing film in which ten layers each of the microparticle film and the organic compound film are laminated was 450 nm, it was inferred that one or two microparticles are present in a Z-axis direction (thickness direction) of a single layer of the microparticle film.

A light signal from a halogen lamp was made incident from one end of the optical waveguide sensor of Experimental Example 19, and a spectrum of transmitted light (600 to 900 nm) from the other end detected by a CCD spectrometer revealed a great loss at approximately 640 nm.

The sensing film was immersed in a 1 mM aqueous solution of tetrakis(sulfophenyl)porphyrin (TSPP, molecular weight Mr=934.99, made by Tokyo Chemical Industry Co., Ltd.) while performing spectrum detection.

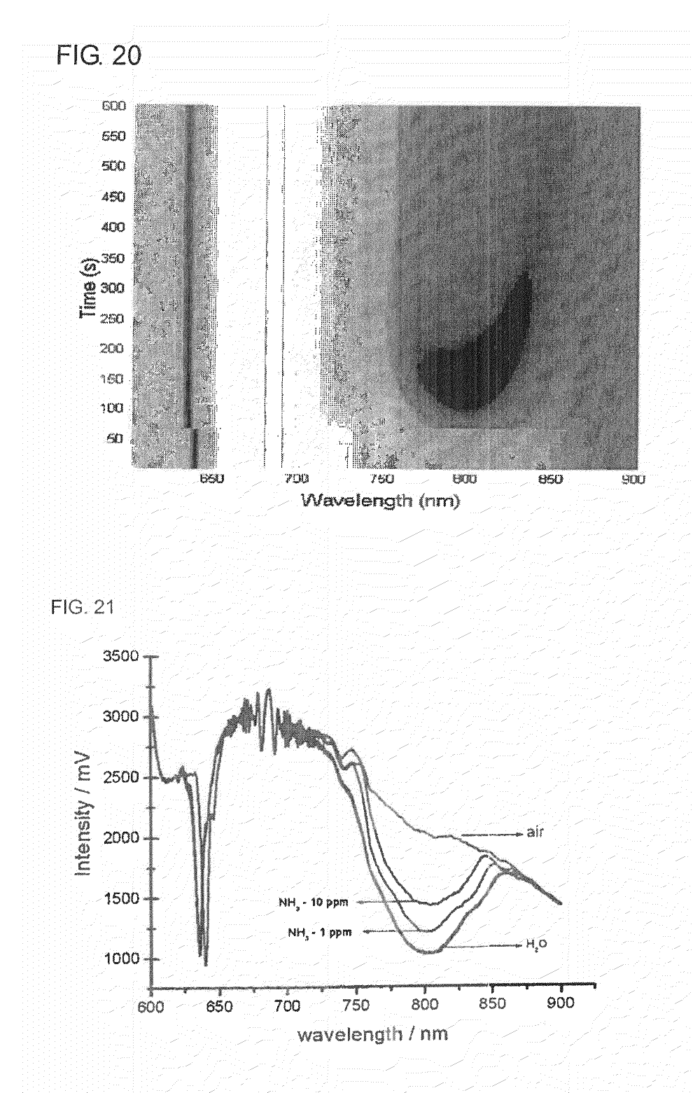

FIG. 20 is a diagram of a time variation of the detected spectrum. The abscissa indicates wavelength (600 to 900 nm), and the ordinate indicates immersion time (time elapsed) (0 to 600 seconds). The color gradation indicates a magnitude of loss, with a darker color indicating a larger loss.

From FIG. 20, it was found that by immersion of the sensing film in the TSPP aqueous solution, a great loss appears anew at approximately 750 nm and higher and especially near 800 nm in addition to the initially detected loss at approximately 640 nm within a short time of approximately 100 seconds. Although TSPP has an absorption band called the Q band near 500 to 700 nm, the loss region near 800 nm is a wavelength region that differs from the Q band of TSPP. It is thus inferred that by bonding of TSPP to the sensing film, the refractive index of the sensing film changes and the spectrum of the transmitted light thus changes.

It was thus confirmed that the optical waveguide sensor of Experiment Example 19 is capable of detecting molecules, such as TSPP. It is considered that this is because with the optical waveguide sensor, comparatively large three-dimensional spaces (pores) that are continuous are formed between the microparticles of the microparticle film, and the molecular (chemical substance) diffusion property is thus excellent and molecules can be adsorbed rapidly inside the three-dimensional spaces (pores).

### Experimental Example 20

The sensing film of the optical waveguide sensor obtained in Experimental Example 19 (before performing the experiment of immersion in the TSPP aqueous solution) was immersed for 20 minutes in a 1 mM aqueous solution of tetrakis(sulfophenyl)porphyrin (TSPP, molecular weight Mr=934.99, made by Tokyo Chemical Industry Co., Ltd.). The sensing film of the optical waveguide sensor was then immersed for 1 minute in ion-exchanged water to rinse off the excess adsorbed portion and dried with nitrogen gas to obtain an optical waveguide sensor of Experimental Example 20 in which TSPP is fixed as a functional molecule to the sensing film.

The sensing film of the optical waveguide sensor of Experimental Example 20 was immersed in 150 μL of distilled water, and the spectrum of transmitted light was measured in the same manner as in Experimental Example 19. After blowing on nitrogen gas to dry the sensing film, the sensing film was immersed in 1 ppm ammonia water (150 μL), and the spectrum of transmitted light was measured in the same manner. The sensing film was then rinsed adequately with ion-exchanged water, drying was performed by blowing on nitrogen gas, immersed in 10 ppm ammonia water (150 μL), and the spectrum of transmitted light was measured in the same manner.

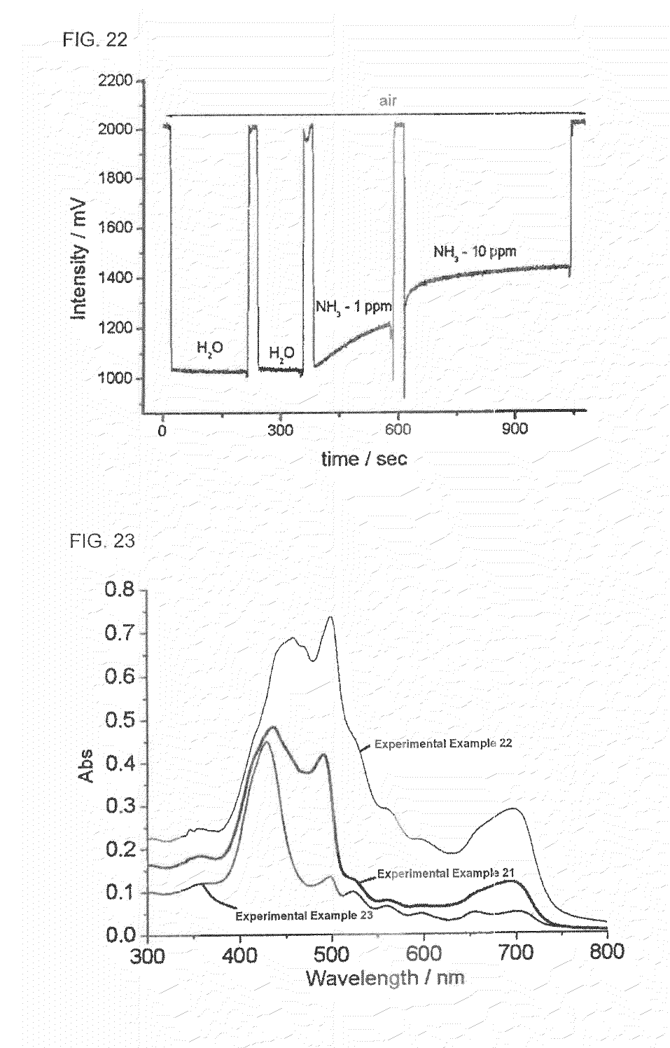

FIG. 21 is a diagram of wavelengths and intensities of the detected spectra, and FIG. 22 is a diagram of spectral intensity at 800 nm wavelength with respect to elapsed time.

From FIGS. 21 and 22, it is clear that the optical waveguide sensor of Experimental Example 20 is high in sensitivity in being able to detect ammonia of 1 ppm rapidly and is high in response speed in that with ammonia of 10 ppm, a stable value is reached in approximately 100 seconds.

### Experimental Examples 21 to 23

As an optical waveguide, a multi-mode optical fiber (HCS200) having a cladding formed of an organic based material, such as a fluoropolymer, etc., on a core made of quartz glass was used. The cladding was removed across a length of 1 cm by melting the cladding by flame, and a core-exposed portion was rinsed adequately with ion-exchanged water and thereafter subject to ultrasonic treatment while being immersed for 20 minutes in a 1 wt % ethanol solution (ethanol:water=3:2, v/v) of potassium hydroxide. After rinsing adequately with ion-exchanged water, drying was performed by blowing on nitrogen gas, and charges (anionic) were thus introduced by the hydroxyl group modification of the surface of the core at the core-exposed portion.

The core-exposed portion was then immersed for 20 minutes in a 0.1 wt % aqueous solution of poly(allylamine hydrochloride) (PAH, molecular weight Mr=70000, made by Sigma-Aldrich Corp.), thereafter immersed for 1 minute in ion-exchanged water to rinse off the excess adsorbed portion, and dried with nitrogen gas to form an organic compound film of poly(allylamine hydrochloride) (PAH) on the surface of the core-exposed portion.

The core-exposed portion was then immersed for 20 minutes in a 20 to 21 wt % aqueous solution of a silica sol (Snowtex 20 L, particle diameter: 40 to 50 nm, anionic, made by Nissan Chemical Industries Ltd.). The core-exposed portion was then immersed for 1 minute in ion-exchanged water to rinse off the excess adsorbed portion and dried with nitrogen gas to form a microparticle film with which silica microparticles are adsorbed on the surface of the organic compound film. An optical waveguide of Experimental Example 21 in which one layer each of the microparticle film and the organic compound film are laminated was thereby obtained.

The formation of the microparticle film and the organic compound film was performed repeatedly by the same method to obtain an optical waveguide of Experimental Example 22 in which three layers each of the microparticle film and the organic compound film are laminated, and the formation of the microparticle film and the organic compound film was performed repeatedly by the same method to obtain an optical waveguide having the sensing film of Experimental Example 23 in which five layers each of the microparticle film and the organic compound film are laminated.

Then, after adequately drying the optical waveguides of Experimental Examples 21 to 23, the core-exposed portion of each optical waveguide was immersed for 2.5 hours in a 1 mM aqueous solution of tetrakis(sulfophenyl)porphyrin (TSPP, molecular weight Mr=934.99, made by Tokyo Chemical Industry Co., Ltd.) as a functional molecule. The respective core-exposed portions were then immersed for 1 minute in ion-exchanged water to rinse off the excess adsorbed portion and dried with nitrogen gas to obtain the optical waveguide sensors of Experimental Examples 21 to 23 in which TSPP is fixed as the functional molecule to the sensing film.

(Characteristics Comparison of the Optical Waveguide Sensors of Experimental Examples 21 to 23)

A standard ammonia gas of 100 ppm and dry air were mixed to prepare arbitrary concentrations, and the ammonia gas was made to flow at 1 L/minute through a gas measurement cell in which each optical waveguide sensor was disposed. After making the ammonia gas flow for 5 minutes, dry air was made to flow through for 5 minutes at 1 L/minute. The time variation of the spectrum was measured at each gas concentration, and an intensity difference of the spectra before and after the inflow of gas was computed. Moreover, as a photodetector, a spectrometer (S1024DW) made by Ocean Optics, Inc. was used, and as a light source that (HL2000) made by Ocean Optics, Inc. was used.

FIG. 23 is a diagram of absorbances as determined from the spectral intensities before and after introduction of the functional molecule (TSPP) to the sensing films in the optical waveguide sensors of Experimental Examples 21 to 23. That is, FIG. 23 shows the absorbances due to the fixed functional molecule (TSPP).

From FIG. 23, it is understood that despite the increase in the number of laminations, the optical waveguide sensor of Experimental Example 23 (five-layer film) is decreased in the absorbance by TSPP in comparison to the optical waveguide sensors of Experimental Examples 21 and 22 (one-layer film and three-layer film). Also, whereas the optical waveguide sensor of Experimental Example 23 (five-layer film) has a Soret band peak at 429 nm, each of the optical waveguide sensors of Experimental Examples 21 and 22 (one-layer film and three-layer film) has Soret band peaks at 491 and 502 nm and a Q band peak near 700 nm, and from the peaks being narrower in width and increased in absorbance in comparison to the peak of the optical waveguide sensor of Experimental Example 23 (five-layer film), it is inferred that with each of the optical waveguide sensors of Experimental Examples 21 and 22 (one-layer film and three-layer film), a J-aggregate, in which a plurality of TSPP molecules are gathered, is present inside the sensing films.

Moreover, the absorbance peak of the optical waveguide sensor of Experimental Example 23 (five-layer film) is similar to the absorbance peak of the aqueous solution of the TSPP monomer. From this, it is inferred that the TSPP in the J-aggregate is decreased in the optical waveguide sensor of Experimental Example 23 (five-layer film).

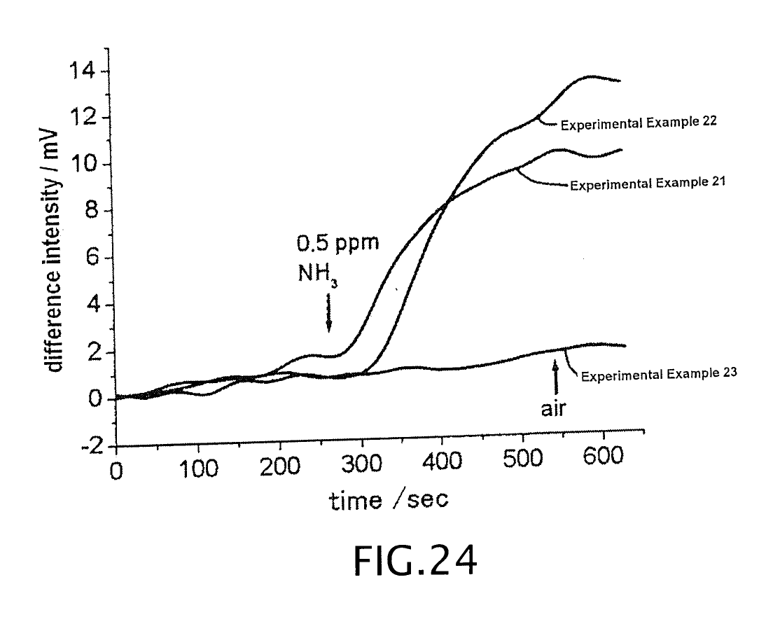

FIG. 24 is a diagram of time variations of spectral intensity difference at 700 nm when the optical waveguide sensors of Experimental Examples 21 to 23 are exposed to 0.5 ppm ammonia gas.

From FIG. 24, it is clear that with the optical waveguide sensors of Experimental Examples 21 and 22 (one-layer film and three-layer film), ammonia of 0.5 ppm is detectable by effective use of evanescent waves and a sensor of high sensitivity can be realized. This is inferred to be due to interaction of ammonia with the TSPP present as the J-aggregate in the sensing film. Also, the optical waveguide sensors of Experimental Examples 21 and 22 (one-layer film and three-layer film) are low in the number of laminations and are thus excellent in productivity.

### Experimental Example 24

As an optical waveguide, a multi-mode optical fiber (HCS200) having a cladding formed of an organic based material, such as a fluoropolymer, etc., on a core made of quartz glass was used. The cladding was removed across a length of 1 cm by melting the cladding by flame to form a core-exposed portion of 1 cm length. The core-exposed portion was rinsed adequately with ion-exchanged water and thereafter subject to ultrasonic treatment while being immersed for 20 minutes in a 1 wt % ethanol solution (ethanol:water=3:2, v/v) of potassium hydroxide. After rinsing adequately with ion-exchanged water, drying was performed by blowing on nitrogen gas, and charges (anionic) were thus introduced by the hydroxyl group modification of the surface of the core at the core-exposed portion.

The core-exposed portion was then immersed for 20 minutes in a 0.5 wt % aqueous solution of poly(diallyldimethylammonium chloride) (PDDA, cationic, weight average molecular weight: 200000-350000, made by Tokyo Chemical Industry Co., Ltd.). The core-exposed portion was then immersed for 1 minute in ion-exchanged water to rinse off the excess adsorbed portion and dried with nitrogen gas to form an organic compound film of poly(diallyldimethylammonium chloride) (PDDA) on the surface of the core-exposed portion.

The core-exposed portion was then immersed for 20 minutes in a 20 to 21 wt % aqueous solution of a silica sol (Snowtex 20 L, particle diameter: 40 to 50 nm, anionic, made by Nissan Chemical Industries Ltd.). The core-exposed portion was then immersed for 1 minute in ion-exchanged water to rinse off the excess adsorbed portion and dried with nitrogen gas to form a microparticle film with which silica microparticles are adsorbed on the surface of the organic compound film. An optical waveguide of Experimental Example 24 in which one layer each of the microparticle film and the organic compound film are laminated was thereby obtained.

Then, after adequately drying the optical waveguide of Experimental Example 24, the core-exposed portion of the optical waveguide was immersed for 20 minutes in a 1 mM aqueous solution of tetrakis(sulfophenyl)porphyrin (TSPP, molecular weight Mr=934.99, made by Tokyo Chemical Industry Co., Ltd.). The core-exposed portion was then immersed for 1 minute in ion-exchanged water to rinse off the excess adsorbed portion and dried with nitrogen gas to obtain the optical waveguide sensor of Experimental Example 24 in which TSPP is fixed as the functional molecule to the sensing film.

By the same method, the optical waveguides of Experimental Examples 25 to 28 (ten layers each) were obtained in which two layers, three layers, five layers, and ten layers each of the microparticle film and the organic compound film are laminated.

After adequately drying the optical waveguides of Experimental Examples 24 to 28 (one layer each), the core-exposed portion of each optical waveguide was immersed for 2.5 hours in a 1 mM aqueous solution of tetrakis(sulfophenyl)porphyrin (TSPP, molecular weight Mr=934.99, made by Tokyo Chemical Industry Co., Ltd.) as a functional molecule. The respective core-exposed portions were then immersed for 1 minute in ion-exchanged water to rinse off the excess adsorbed portion and dried with nitrogen gas to obtain the optical waveguide sensors of Experimental Examples 24 to 28 in which TSPP is fixed as the functional molecule to the sensing film.

(Characteristics Comparison of the Optical Waveguide Sensors of Experimental Examples 24 to 28)

A standard ammonia gas of 0.897 ppm and dry air were mixed and attenuate to prepare concentrations of 0.45, 0.89, 45, 89, 268, and 447 ppb, and each ammonia gas was made to flow at 1 L/minute through a gas measurement cell in which each optical waveguide sensor was disposed. After making the ammonia gas flow for 5 minutes, dry air was made to flow through for 5 minutes at 1 L/minute The time variation of the spectrum was measured at each gas concentration, and an intensity difference of the spectra before and after the inflow of gas was computed. Moreover, as the photodetector, the spectrometer (S1024DW) made by Ocean Optics, Inc. was used, and as the light source that (HL2000) made by Ocean Optics, Inc. was used.

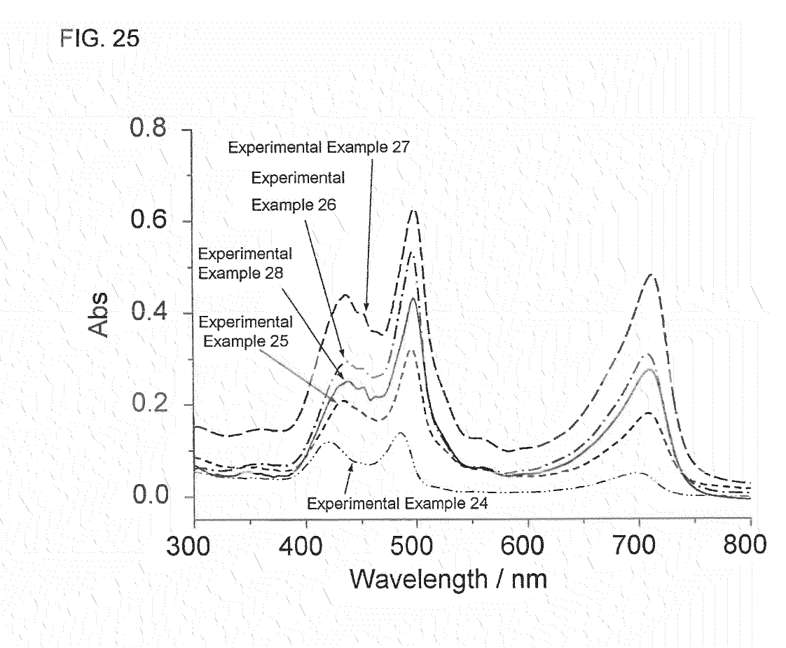

FIG. 25 is a diagram of absorbances as determined from the spectral intensities before and after introduction of the functional molecule (TSPP) to the sensing films in the optical waveguide sensors of Experimental Examples 24 to 28. That is, FIG. 25 shows the absorbances due to the fixed functional molecule (TSPP).

From FIG. 25, it is understood that despite the increase in the number of laminations, the optical waveguide sensor of Experimental Example 28 (each ten-layer film) is decreased in the absorbance by TSPP in comparison to the optical waveguide sensors of Experimental Examples 26 and 27 (each three-layer film and each five-layer film). Also, whereas the optical waveguide sensor of Experimental Example 28 (each ten-layer film) has a Soret band peak at 429 nm, the optical waveguide sensor of Experimental Example 27 (each three-layer film and each five-layer film) has Soret band peaks at 430 and 500 nm and a Q band peak near 710 nm, and from the peaks being narrower in width and increased in absorbance in comparison to the peak of the optical waveguide sensor of Experimental Example 28 (each ten-layer film), it is inferred that with the optical waveguide sensor of Experimental Example 27 (each five-layer film), a J-aggregate, in which a plurality of TSPP molecules are gathered, is present inside the sensing film.

The absorbance peak of the optical waveguide sensor of Experimental Example 28 (each ten-layer film) is similar to the absorbance peak of the aqueous solution of the TSPP monomer. From this, it is inferred that the TSPP in the J-aggregate is decreased in the optical waveguide sensor of Experimental Example 28 (each ten-layer film).

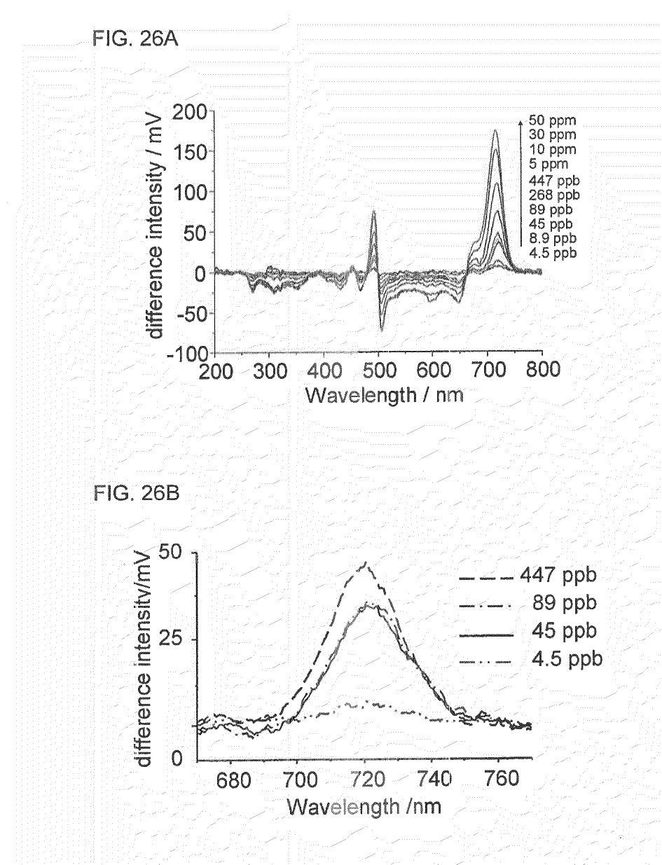

FIG. 26A is a diagram of intensity differences of differential spectra when the optical waveguide sensor of Experimental Example 27 is exposed to ammonia gases of low concentrations, and FIG. 26B is an enlarged view of the intensity differences of the differential spectra near 720 nm.

As is clear from FIG. 26, with the optical waveguide sensor of Experimental Example 27 (each five-layer film), effective use of the evanescent waves is made to provide intensity changes of 8.7 mV at 4.5 ppb and 79 mV at 447 ppb, and a limit of detection (LOD) was estimated to be 2.1 ppb. From this result, it is clear that ammonia gas of extremely low concentration is detectable and a sensor of high sensitivity can be realized. It is inferred that the pores inside sensing film improve the gas diffusion property and thereby promote the reaction of TSPP and ammonia inside the sensing film.

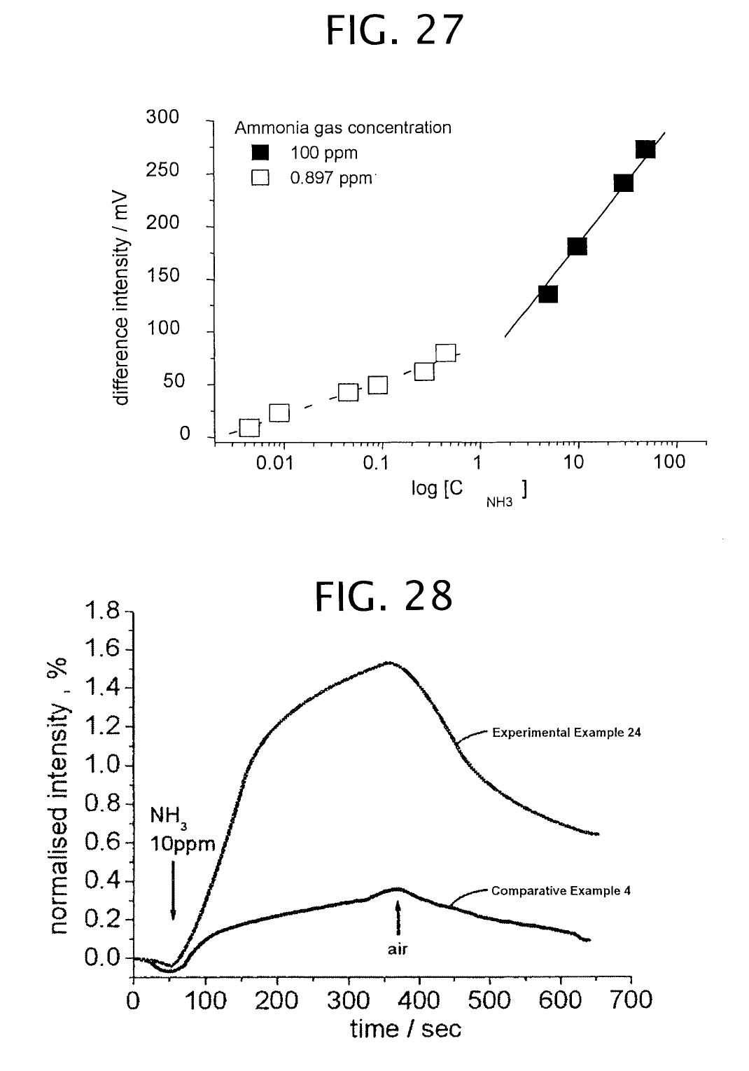

FIG. 27 is a diagram of ammonia gas concentration dependence of the spectral intensity (710 nm) of the optical waveguide sensor of Experimental Example 27.

FIG. 27 shows results of measurements made upon mixingly using a standard ammonia gas of 0.897 ppm (shown by white squares) and dry air to prepare ammonia gases of concentrations of 0.45, 0.89, 45, 89, 268, and 447 ppb and mixingly using a standard ammonia gas of 100 ppm (shown by black squares) and dry air to prepare ammonia gases of concentrations of 5, 10, 30, and 50 ppm. It was found that the optical waveguide sensor of Experimental Example 27, though exhibiting a gradient of sensitivity at 1 ppm ammonia gas concentration as a reference point, exhibits a concentration dependence that is high at no more than 1 ppm or at no less than 1 ppm.

### Comparative Example 4

As an optical waveguide, a multi-mode optical fiber (HCS200) having a cladding formed of an organic based material, such as a fluoropolymer, etc., on a core made of quartz glass was used. The cladding was removed across a length of 1 cm by melting the cladding by flame to form a core-exposed portion of 1 cm length. The core-exposed portion was rinsed adequately with ion-exchanged water and thereafter subject to ultrasonic treatment while being immersed for 20 minutes in a 1 wt % ethanol solution (ethanol:water=3:2, v/v) of potassium hydroxide. After rinsing adequately with ion-exchanged water, drying was performed by blowing on nitrogen gas, and charges (anionic) were thus introduced by the hydroxyl group modification of the surface of the core at the core-exposed portion.

The core-exposed portion was then immersed for 20 minutes in a 0.5 wt % aqueous solution of poly(diallyldimethylammonium chloride) (PDDA, cationic, weight average molecular weight: 200000-350000, made by Tokyo Chemical Industry Co., Ltd.). The core-exposed portion was then immersed for 1 minute in ion-exchanged water to rinse off the excess adsorbed portion and dried with nitrogen gas to form an organic compound film of poly(diallyldimethylammonium chloride) (PDDA) on the surface of the core-exposed portion.

The core-exposed portion of the optical waveguide was then immersed for 20 minutes in a 1 mM aqueous solution of tetrakis(sulfophenyl)porphyrin (TSPP, molecular weight Mr=934.99, made by Tokyo Chemical Industry Co., Ltd.). The core-exposed portion was then immersed for 1 minute in ion-exchanged water to rinse off the excess adsorbed portion and dried with nitrogen gas to thereby laminate an organic compound film (TSPP) onto the organic compound film (PDDA).

Lamination of the organic compound film (PDDA) and the organic compound film (TSPP) was performed alternately to obtain an optical waveguide sensor of Comparative Example 4 in which ten layers each of the organic compound film (PDDA) and the organic compound film (TSPP) are laminated.

(Characteristics Comparison of the Optical Waveguide Sensors of Experimental Example 24 and Comparative Example 4)

Characteristics of the optical waveguide sensors of Experimental Example 24 and Comparative Example 4 were compared in the same manner as in the measurements of the characteristics of the optical waveguide sensors of Experimental Examples 21 to 23.

FIG. 28 is a diagram of time variations of spectral intensity difference at 700 nm when the optical waveguide sensors of Experimental Example 24 and Comparative Example 4 are exposed to ammonia gas of 10 ppm.

From FIG. 28, it is understood that despite ten layers each of the organic compound film (PDDA) and the organic compound film (TSPP) being laminated, the optical waveguide sensor of Comparative Example 4 is lower in sensitivity and slower in response speed in comparison to the optical waveguide sensor of Experimental Example 24.

From the above, it is clear that the optical waveguide sensor of Experimental Example 24 enables increase in the number of reactive sites and enables realization of a sensor of high sensitivity and excellent responsivity due to having the microparticle film and is furthermore excellent in productivity due to the number of laminations being low.

As described above, it was confirmed that optical waveguide sensors that are high in detection sensitivity and also excellent in responsivity can be provided by the present examples. This significant effect is realized by large three-dimensional spaces of excellent diffusion property being formed in the microparticle film and the organic compound film by the pores formed in the microparticle film.

Also in a separately conducted experiment, it was confirmed that even a polymer such as polyacrylic acid (molecular weight Mr=4000000) can diffuse in the three-dimensional spaces formed in the microparticle films and the organic compound films. It is thus clear that polymers, such as proteins and nucleic acids, can diffuse through the microparticle films and the organic compound films and modify the microparticle films and the organic compound films. The optical waveguide sensors of the present examples can thus be said to be widely applicable not only as sensors for gas molecules, acids and bases, etc., but also as biosensors, such as immunoassay sensors, etc.

### INDUSTRIAL APPLICABILITY

The present invention relates to a composite thin film in which an organic compound film is laminated, and to an atmosphere sensor and an optical waveguide sensor that each includes the composite thin film, and can provide a composite thin film that, due to enabling expansion of a surface area of the organic compound film on the surface of which specific molecules are adsorbed and enabling increase in the number of reactive sites per single layer of the organic compound film, can be produced with a low number of laminations, is excellent in productivity, and is further excellent in applicability in being applicable to highly sensitive sensors and molecular devices of improved function, can provide an atmosphere sensor, which, due to enabling expansion of the surface area of the organic compound film on the surface of which gas molecules or water molecules are adsorbed and enabling increase in the number of reactive sites per single layer of the organic compound film, can be produced with a low number of laminations, is excellent in productivity, and further can not only be improved in the detection sensitivity of gas or humidity but is also excellent in molecular diffusion property and excellent in responsivity, and can provide an optical waveguide sensor that can be used in a chemical sensor, etc., and that, due to enabling expansion of the surface area of the organic compound film that adsorbs a chemical substance and enabling increase in the number of reactive sites per single layer of the organic compound film, can be produced with a low number of laminations, is excellent in productivity, and can not only be improved in the detection sensitivity but is also excellent in molecular diffusion property and excellent in responsivity.

1. A composite thin film formed on a surface of a support and comprising at least one layer each of films (a) and (b) on the surface of the support:
(a) a microparticle film formed by adsorption of silica microparticles with an average particle diameter of 10 to 100 nm and with which particle diameters are distributed within a range of ±20 nm about the average particle diameter, having pores of substantially equal size between microparticles; and
(b) an organic compound film formed by adsorption of an organic compound.

2. The composite thin film according to claim 1, wherein the microparticle film is formed on an outermost layer and the organic compound film is formed by adsorption of the organic compound on a surface of the microparticle film.

3. The composite thin film according to claim 1, wherein the microparticle film and the organic compound film are laminated alternately a plurality of times.

4. The composite thin film according to claim 1, wherein the microparticles have an average particle diameter of 30 to 80 nm.

5. The composite thin film according to claim 1, wherein a functional molecule is fixed to both or either of the organic compound film and the microparticle film.

6. An atmosphere sensor comprising the composite thin film according to claim 1 and wherein the support is a core of an optical waveguide or is a piezoelectric substrate.

7. An optical waveguide sensor comprising the composite thin film according to claim 1 as a sensing film and with which the support is an optical waveguide.

8-9. (canceled)

10. The composite thin film according to claim 2, wherein the microparticle film and the organic compound film are laminated alternately a plurality of times.

11. The composite thin film according to claim 2, wherein a functional molecule is fixed to both or either of the organic compound film and the microparticle film.

12. An atmosphere sensor comprising the composite thin film according to claim 2 and wherein the support is a core of an optical waveguide or is a piezoelectric substrate.

13. An atmosphere sensor comprising the composite thin film according to claim 5 and wherein the support is a core of an optical waveguide or is a piezoelectric substrate.

14. An atmosphere sensor comprising the composite thin film according to claim 11 and wherein the support is a core of an optical waveguide or is a piezoelectric substrate.

15. An optical waveguide sensor comprising the composite thin film according to claim 2 as a sensing film and with which the support is an optical waveguide.

16. An optical waveguide sensor comprising the composite thin film according to claim 5 as a sensing film and with which the support is an optical waveguide.

17. An optical waveguide sensor comprising the composite thin film according to claim 11 as a sensing film and with which the support is an optical waveguide.
